(19) United States
(12) Patent Application Publication
(10) Pub. No.: US 2019/0394816 A1
(43) Pub. Date: Dec. 26, 2019

(54) METHOD FOR TRANSMITTING AND RECEIVING DATA THROUGH RELAY IN WIRELESS COMMUNICATION SYSTEM AND APPARATUS THEREFOR

(71) Applicant: LG Electronics Inc., Seoul (KR)

(72) Inventor: Taehun KIM, Seoul (KR)

(21) Appl. No.: 16/488,173

(22) PCT Filed: Feb. 21, 2018
(86) PCT No.: PCT/KR2018/002142

§ 371 Date: Aug. 22, 2019

Related U.S. Application Data
(60) Provisional application No. 62/463,653, filed on Feb. 25, 2017.
(60) Provisional application No. 62/461,798, filed on Feb. 22, 2017.

(51) Int. Cl. H04W 76/11

(52) U.S. Cl. CPC H04W 76/11; H04W 88/04

(57) ABSTRACT

Disclosed herein are a method and an apparatus for transmitting and receiving, by a base station, data of remote user equipment (remote UE) through relay UE in a wireless communication system. According to the present invention, there may be provided a method for transmitting and receiving data through a relay including: receiving an S1 application protocol (S1AP) message for establishing an E-UTRAN radio access bearer (E-RAB) of the remote UE from a mobility management entity (MME), transmitting a first RRC message for establishing a data radio bearer (DRB) corresponding to the E-RAB to the relay UE, receiving a first RRC response message as a response to the first RRC message from the relay UE, and transmitting an S1AP response message as a response to an S1AP message to the MME if the first RRC response message includes a local identifier of the remote UE allocated by the base station, and an apparatus therefor.

### TECHNICAL FIELD

The present invention relates to a wireless communication system, and more particularly, to a method for transmitting and receiving, by a remote user equipment) data to and from a network through a relay user equipment and an apparatus therefor.

### BACKGROUND ART

Mobile communication systems have been developed to provide voice services, while guaranteeing user activity. Service coverage of mobile communication systems, however, has extended even to data services, as well as voice services, and currently, an explosive increase in traffic has resulted in shortage of resource and user demand for a high speed services, requiring advanced mobile communication systems.

The requirements of the next-generation mobile communication system may include supporting huge data traffic, a remarkable increase in the transfer rate of each user, the accommodation of a significantly increased number of connection devices, very low end-to-end latency, and high energy efficiency. To this end, various techniques, such as small cell enhancement, dual connectivity, massive Multiple Input Multiple Output (MIMO), in-band full duplex, non-orthogonal multiple access (NOMA), supporting super-wide band, and device networking, have been researched.

### DISCLOSURE

### Technical Problem

An embodiment of the present invention provides a method for transmitting and receiving data to and from a network via a relay UE connected to a remote UE through PC5 (that is, air interface/reference point between UEs).

Furthermore, an embodiment of the present invention provides a method for remote UE to transmit and receive data to and from a network through relay UE by allowing a base station to configure a radio data bearer for the relay UE and the remote UE.

Furthermore, an embodiment of the present invention provides a method for remote UE to recognize whether a radio data bearer for remote UE is configured between relay UE and a base station.

Furthermore, an embodiment of the present invention provides a method for configuring an additional radio data bearer when the radio data bearer for remote UE configured between relay UE and a base station cannot support traffic of the remote UE.

Furthermore, an embodiment of the present invention provides a method for releasing a radio data bearer for remote UE configured between relay UE and a base station.

Furthermore, an embodiment of the present invention provides a method for releasing only a radio data bearer for remote UE configured between relay UE and a base station while the relay UE keeping a connected state.

Objects of the present invention are not limited to the above-mentioned objects. That is, other objects that are not mentioned may be obviously understood by those skilled in the art to which the present invention pertains from the following description.

### Technical Solution

Furthermore, in this specification, a method for transmitting and receiving, by a base station, data of remote user equipment (remote UE) through relay UE in a wireless communication system includes: receiving an S1 application protocol (S1AP) message for establishing an E-UTRAN radio access bearer (E-RAB) of the remote UE from a mobility management entity (MME); transmitting a first RRC message for establishing a data radio bearer (DRB) corresponding to the E-RAB to the relay UE; receiving a first RRC response message as a response to the first RRC message from the relay UE; and transmitting an S1AP response message as a response to an S1AP message to the MME if the first RRC response message includes a local identifier of the remote UE allocated by the base station.

The local identifier may be included in the RRC response message when the relay UE receives a response message from the remote UE, and the response message may be a response message to a message indicating that an RRC connection between the relay UE and the base station is successfully completed.

The method may further include: receiving a NAS message encapsulated in an RRC message to establish the DRB from the relay UE; and transmitting the NAS message encapsulated in the S1AP to the MME.

The NAS message may include an indicator indicating whether the NAS message is relayed through the remote UE and the relay UE.

The S1AP message may include at least one of UE context information and bearer context information of the relay UE and the remote UE.

The method may further include: mapping at least one radio data bearer established between the relay UE and the base station to a bearer for the remote UE based on the bearer context information; and allocating the local identifier for identifying the remote UE.

The first RRC message may include mapping information associated with the mapping of the at least one radio data bearer and the local identifier.

The method may further include: establishing an additional DRB for supporting the remote UE when the DRB previously established between the relay UE and the base station is unable to support uplink and downlink transmission of the remote UE.

It may be determined whether the DRB previously established between the relay UE and the base station is unable to support the uplink and downlink transmission of the remote UE based on at least one of authorization of the relay UE or capability of the relay UE.

The DRB may be used for transmitting and receiving a first data of the remote UE or a second data multiplexed with the first data and data of at least one other UE.

The method may further include: transmitting to the relay UE a second RRC message for releasing only the DRB configured for the remote UE between the base station and the relay UE.

The S1AP message may include an indicator indicating that the S1AP message is a message for the remote UE.

Furthermore, in this specification, a base station for transmitting and receiving data of remote user equipment (remote UE) through relay UE in a wireless communication system includes: a communication module configured to transmit and receive a wired/wireless signal; and a processor configured to control the communication module, in which the processor may receive an S1 application protocol (S1AP) message for requesting a configuration of a UE context of the remote UE (for establishing an E-UTRAN radio access bearer) from a mobility management entity (MME), transmit a first RRC message for establishing a data radio bearer (DRB) corresponding to the E-RAB to the relay UE, receive a first RRC response message as a response to the first RRC message from the relay UE, and transmit an initial context setup response message as a response to an S1AP message to the MME if the first RRC response message includes a local identifier of the remote UE allocated by the base station.

### Advantageous Effects

According to the embodiment of the present invention, it is possible to effectively configure the radio data bearer for transmitting and receiving the user traffic of the remote UE between the relay UE and the base station.

In addition, according to the embodiment of the present invention, when the radio data bearer for transmitting and receiving the user traffic of the remote UE between the relay UE and the base station cannot support the user traffic of the remote UE, it is possible to effectively transmit and receive the user traffic of the remote UE by additionally configuring the radio data bearer.

In addition, according to the embodiment of the present invention, it is possible to release only the radio data bearer for the remote UE configured between the relay UE and the base station while the connection between the relay UE and the base station is maintained.

Effects which can be achieved by the present invention are not limited to the above-mentioned effects. That is, other objects that are not mentioned may be obviously understood by those skilled in the art to which the present invention pertains from the following description.

### DESCRIPTION OF DRAWINGS

In order to help understanding of the present invention, the accompanying drawings which are included as a part of the Detailed Description provide embodiments of the present invention and describe the technical features of the present invention together with the Detailed Description.

FIG. 1 is a diagram schematically illustrating an evolved packet system (EPS) to which the present invention may be applied.

FIG. 2 illustrates an example of a network structure of an evolved universal terrestrial radio access network (E-UTRAN) to which the present invention may be applied.

FIG. 3 illustrates structures of E-UTRAN and EPC in a wireless communication system to which the present invention may be applied.

FIG. 4 illustrates a radio interface protocol structure between a UE and the E-UTRAN in the wireless communication system to which the present invention may be applied.

FIG. 5 is a diagram schematically illustrating a structure of a physical channel in the wireless communication system to which the present invention may be applied.

FIG. 6 is a diagram for describing a contention based random access procedure in the wireless communication system to which the present invention may be applied.

FIG. 7 illustrates a direct link setup procedure in the wireless communication system to which the present invention may be applied.

FIG. 8 illustrates a direct link keepalive procedure in the wireless communication system to which the present invention may be applied.

FIG. 9 may be configured through a direct link release procedure in the wireless communication system to which the present invention may be applied.

FIG. 10 illustrates a direct security mode control procedure in the wireless communication system to which the present invention may be applied.

FIG. 11 is a diagram exemplifying a UE trigger service request procedure in the wireless communication system to which the present invention can be applied.

FIG. 12 is a diagram exemplifying an S1 release procedure in a wireless communication system to which the present invention can be applied.

FIG. 13 is a diagram illustrating an initial context setup procedure to which the present invention can be applied.

FIG. 14 is a diagram illustrating an initial context setup procedure to which the present invention can be applied.

FIG. 15 is a diagram illustrating a data transmission method through a configuration of a radio data bearer for a remote UE according to an embodiment of the present invention.

FIG. 16 is a diagram illustrating a data transmission method through a configuration of a radio data bearer for a remote UE according to an embodiment of the present invention.

FIG. 17 is a diagram illustrating a method for releasing a radio data bearer according to an embodiment of the present invention.

FIG. 18 is a diagram illustrating a method for releasing a radio data bearer according to an embodiment of the present invention.

FIG. 19 illustrates a block diagram of a communication device according to an embodiment of the present invention.

FIG. 20 illustrates a block diagram of a communication device according to an embodiment of the present invention.

### MODE FOR INVENTION

In what follows, preferred embodiments according to the present invention will be described in detail with reference to appended drawings. The detailed descriptions provided below together with appended drawings are intended only to explain illustrative embodiments of the present invention, which should not be regarded as the sole embodiments of the present invention. The detailed descriptions below include specific information to provide complete understanding of the present invention. However, those skilled in the art will be able to comprehend that the present invention may be embodied without the specific information.

For some cases, to avoid obscuring the technical principles of the present invention, structures and devices well-known to the public may be omitted or may be illustrated in the form of block diagrams utilizing fundamental functions of the structures and the devices.

A base station in this document is regarded as a terminal node of a network, which performs communication directly with a UE. In this document, particular operations regarded to be performed by the base station may be performed by an upper node of the base station depending on situations. In other words, it is apparent that in a network consisting of a plurality of network nodes including a base station, various operations performed for communication with a UE may be performed by the base station or by network nodes other than the base station. The term Base Station (BS) may be replaced with a fixed station, Node B, evolved-NodeB (eNB), Base Transceiver System (BTS), or Access Point (AP). Also, a terminal may be fixed or mobile; and the term may be replaced with User Equipment (UE), Mobile Station (MS), User Terminal (UT), Mobile Subscriber Station (MSS), Subscriber Station (SS), Advanced Mobile Station (AMS), Wireless Terminal (WT), Machine-Type Communication (MTC) device, Machine-to-Machine (M2M) device, or Device-to-Device (D2D) device.

In what follows, downlink (DL) refers to communication from a base station to a terminal, while uplink (UL) refers to communication from a terminal to a base station. In downlink transmission, a transmitter may be part of the base station, and a receiver may be part of the terminal. Similarly, in uplink transmission, a transmitter may be part of the terminal, and a receiver may be part of the base station.

Specific terms used in the following descriptions are introduced to help understanding the present invention, and the specific terms may be used in different ways as long as it does not leave the technical scope of the present invention.

The technology described below may be used for various types of wireless access systems based on Code Division Multiple Access (CDMA), Frequency Division Multiple Access (FDMA), Time Division Multiple Access (TDMA), Orthogonal Frequency Division Multiple Access (OFDMA), Single Carrier Frequency Division Multiple Access (SC-FDMA), or Non-Orthogonal Multiple Access (NOMA). CDMA may be implemented by such radio technology as Universal Terrestrial Radio Access (UTRA) or CDMA2000. TDMA may be implemented by such radio technology as Global System for Mobile communications (GSM), General Packet Radio Service (GPRS), or Enhanced Data rates for GSM Evolution (EDGE). OFDMA may be implemented by such radio technology as the IEEE 802.11 (Wi-Fi), the IEEE 802.16 (WiMAX), the IEEE 802-20, or Evolved UTRA (E-UTRA). UTRA is part of the Universal Mobile Telecommunications System (UMTS). The 3rd Generation Partnership Project (3GPP) Long Term Evolution (LTE) is part of the Evolved UMTS (E-UMTS) which uses the E-UTRA, employing OFDMA for downlink and SC-FDMA for uplink transmission. The LTE-A (Advanced) is an evolved version of the 3GPP LTE system.

Embodiments of the present invention may be supported by standard documents disclosed in at least one of wireless access systems including the IEEE 802, 3GPP, and 3GPP2 specifications. In other words, among the embodiments of the present invention, those steps or parts omitted for the purpose of clearly describing technical principles of the present invention may be supported by the documents above. Also, all of the terms disclosed in this document may be explained with reference to the standard documents.

To clarify the descriptions, this document is based on the 3GPP LTE/LTE-A, but the technical features of the present invention are not limited to the current descriptions.

Terms used in this document are defined as follows.
Universal Mobile Telecommunication System (UMTS): the 3rd generation mobile communication technology based on GSM, developed by the 3GPP
Evolved Packet System (EPS): a network system comprising an Evolved Packet Core (EPC), a packet switched core network based on the Internet Protocol (IP) and an access network such as the LTE and UTRAN. The EPS is a network evolved from the UMTS.
NodeB: the base station of the UMTS network. NodeB is installed outside and provides coverage of a macro cell.
eNodeB: the base station of the EPS network. eNodeB is installed outside and provides coverage of a macro cell.
User Equipment (UE): A UE may be called a terminal, Mobile Equipment (ME), or Mobile Station (MS). A UE may be a portable device such as a notebook computer, mobile phone, Personal Digital Assistant (PDA), smart phone, or a multimedia device; or a fixed device such as a Personal Computer (PC) or vehicle-mounted device. The term UE may refer to an MTC terminal in the description related to MTC.
IP Multimedia Subsystem (IMS): a sub-system providing multimedia services based on the IP
International Mobile Subscriber Identity (IMSI): a globally unique subscriber identifier assigned in a mobile communication network
Machine Type Communication (MTC): communication performed by machines without human intervention. It may be called Machine-to-Machine (M2M) communication.
MTC terminal (MTC UE or MTC device): a terminal (for example, a vending machine, meter, and so on) equipped with a communication function operating through a mobile communication network (For example, communicating with an MTC server via a PLMN) and performing an MTC function
MTC server: a server on a network managing MTC terminals. It may be installed inside or outside a mobile communication network. It may provide an interface through which an MTC user may access the server. Also, an MTC server may provide MTC-related services to other servers (in the form of Services Capability Server (SCS)) or the MTC server itself may be an MTC Application Server.
(MTC) application: services (to which MTC is applied) (for example, remote metering, traffic movement tracking, weather observation sensors, and so on)
(MTC) Application Server: a server on a network in which (MTC) applications are performed
MTC feature: a function of a network to support MTC applications. For example, MTC monitoring is a feature intended to prepare for loss of a device in an MTC application such as remote metering, and low mobility is a feature intended for an MTC application with respect to an MTC terminal such as a vending machine.
MTC User (MTC User): The MTC user uses the service provided by the MTC server.
MTC subscriber: an entity having a connection relationship with a network operator and providing services to one or more MTC terminals.
MTC group: an MTC group shares at least one or more MTC features and denotes a group of MTC terminals belonging to MTC subscribers.
Services Capability Server (SCS): an entity being connected to the 3GPP network and used for communicating with an MTC InterWorking Function (MTC-IWF) on a Home PLMN (HPLMN) and an MTC terminal. The SCS provides the capability for use by one or more MTC applications.
External identifier: a globally unique identifier used by an external entity (for example, an SCS or an Application Server) of the 3GPP network to indicate (or identify) an MTC terminal (or a subscriber to which the MTC terminal belongs). An external identifier includes a domain identifier and a local identifier as described below.
Domain identifier: an identifier used for identifying a domain in the control region of a mobile communication network service provider. A service provider may use a separate domain identifier for each service to provide an access to a different service.
Local identifier: an identifier used for deriving or obtaining an International Mobile Subscriber Identity (IMSI). A local identifier should be unique within an application domain and is managed by a mobile communication network service provider.
Radio Access Network (RAN): a unit including a Node B, a Radio Network Controller (RNC) controlling the Node B, and an eNodeB in the 3GPP network. The RAN is defined at the terminal level and provides a connection to a core network.
Home Location Register (HLR)/Home Subscriber Server (HSS): a database provisioning subscriber information within the 3GPP network. An HSS may perform functions of configuration storage, identity management, user state storage, and so on.
RAN Application Part (RANAP): an interface between the RAN and a node in charge of controlling a core network (in other words, a Mobility Management Entity (MME)/Serving GPRS (General Packet Radio Service) Supporting Node (SGSN)/Mobile Switching Center (MSC)).
Public Land Mobile Network (PLMN): a network formed to provide mobile communication services to individuals. The PLMN may be formed separately for each operator.
Service Capability Exposure Function (SCEF): An entity within the 3GPP architecture for service capability exposure that provides a means for securely exposing services and capabilities provided by 3GPP network interfaces.

In what follows, the present invention will be described based on the terms defined above.

Overview of System to which the Present Invention May be Applied

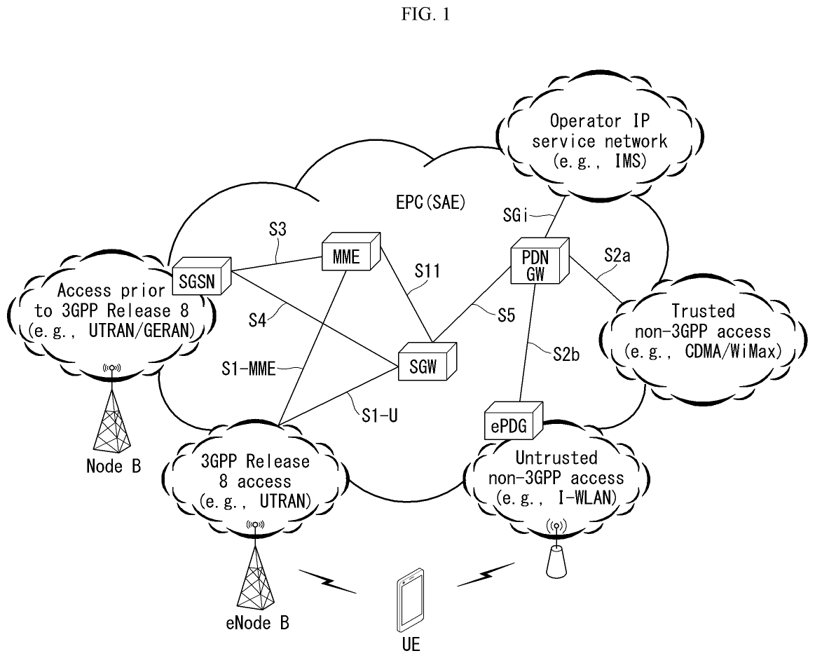

FIG. 1 illustrates an Evolved Packet System (EPS) to which the present invention may be applied.

The network structure of FIG. 1 is a simplified diagram restructured from an Evolved Packet System (EPS) including Evolved Packet Core (EPC).

The EPC is a main component of the System Architecture Evolution (SAE) intended for improving performance of the 3GPP technologies. SAE is a research project for determining a network structure supporting mobility between multiple heterogeneous networks. For example, SAE is intended to provide an optimized packet-based system which supports various IP-based wireless access technologies, provides much more improved data transmission capability, and so on.

More specifically, the EPC is the core network of an IP-based mobile communication system for the 3GPP LTE system and capable of supporting packet-based real-time and non-real time services. In the existing mobile communication systems (namely, in the 2nd or 3rd mobile communication system), functions of the core network have been implemented through two separate sub-domains: a Circuit-Switched (CS) sub-domain for voice and a Packet-Switched (PS) sub-domain for data. However, in the 3GPP LTE system, an evolution from the 3rd mobile communication system, the CS and PS sub-domains have been unified into a single IP domain. In other words, in the 3GPP LTE system, connection between UEs having IP capabilities may be established through an IP-based base station (for example, eNodeB), EPC, and application domain (for example, IMS). In other words, the EPC provides the architecture essential for implementing end-to-end IP services.

The EPC includes various components, where FIG. 1 illustrates part of the EPC components, including a Serving Gateway (SGW or S-GW), Packet Data Network Gateway (PDN GW or PGW or P-GW), Mobility Management Entity (MME), Serving GPRS Supporting Node (SGSN), and enhanced Packet Data Gateway (ePDG).

The SGW operates as a boundary point between the Radio Access Network (RAN) and the core network and maintains a data path between the eNodeB and the PDN GW. Also, if UE moves across serving areas by the eNodeB, the SGW acts as an anchor point for local mobility. In other words, packets may be routed through the SGW to ensure mobility within the E-UTRAN (Evolved-UMTS (Universal Mobile Telecommunications System) Terrestrial Radio Access Network defined for the subsequent versions of the 3GPP release 8). Also, the SGW may act as an anchor point for mobility between the E-UTRAN and other 3GPP networks (the RAN defined before the 3GPP release 8, for example, UTRAN or GERAN (GSM (Global System for Mobile Communication)/EDGE (Enhanced Data rates for Global Evolution) Radio Access Network).

The PDN GW corresponds to a termination point of a data interface to a packet data network. The PDN GW may support policy enforcement features, packet filtering, charging support, and so on. Also, the PDN GW may act as an anchor point for mobility management between the 3GPP network and non-3GPP networks (for example, an unreliable network such as the Interworking Wireless Local Area Network (I-WLAN) or reliable networks such as the Code Division Multiple Access (CDMA) network and WiMax).

In the example of a network structure as shown in FIG. 1, the SGW and the PDN GW are treated as separate gateways; however, the two gateways may be implemented according to single gateway configuration option.

The MME performs signaling for the UE's access to the network, supporting allocation, tracking, paging, roaming, handover of network resources, and so on; and control functions. The MME controls control plane functions related to subscribers and session management. The MME manages a plurality of eNodeBs and performs signaling of the conventional gateway's selection for handover to other 2G/3G networks. Also, the MME performs such functions as security procedures, terminal-to-network session handling, idle terminal location management, and so on.

The SGSN deals with all kinds of packet data including the packet data for mobility management and authentication of the user with respect to other 3GPP networks (for example, the GPRS network).

The ePDG acts as a security node with respect to an unreliable, non-3GPP network (for example, I-WLAN, WiFi hotspot, and so on).

As described with respect to FIG. 1, a UE with the IP capability may access the IP service network (for example, the IMS) that a service provider (namely, an operator) provides, via various components within the EPC based not only on the 3GPP access but also on the non-3GPP access.

Also, FIG. 1 illustrates various reference points (for example, S1-U, S1-MME, and so on). The 3GPP system defines a reference point as a conceptual link which connects two functions defined in disparate functional entities of the E-UTAN and the EPC. Table 1 below summarizes reference points shown in FIG. 1. In addition to the examples of FIG. 1, various other reference points may be defined according to network structures.

TABLE 1

| reference point | Description |
|---|---|
| S1-MME | Reference point for the control plane protocol between E-UTRAN and MME |
| S1-U | Reference point between E-UTRAN and Serving GW for the per bearer user plane |
| | tunneling and inter eNodeB path switching during handover |
| S3 | It enables user and bearer information exchange for inter 3GPP access network |
| | mobility in idle and/or active state. This reference point may be used intra-PLMN |
| | or inter-PLMN (e.g. in the case of Inter-PLMN HO). |
| S4 | It provides related control and mobility support between GPRS core and the 3GPP |
| | anchor function of Serving GW. In addition, if direct tunnel is not established, it |
| | provides the user plane tunneling. |
| S5 | It provides user plane tunneling and tunnel management between Serving GW and |
| | PDN GW. It is used for Serving GW relocation due to UE mobility if the Serving |
| | GW needs to connect to a non-collocated PDN GW for the required PDN |
| | connectivity. |
| S11 | Reference point for the control plane protocol between MME and SGW |
| SGi | It is the reference point between the PDN GW and the packet data network. Packet |
| | data network may be an operator external public or private packet data network or |
| | an intra-operator packet data network (e.g., for provision of IMS services). This |
| | reference point corresponds to Gi for 3GPP accesses. |

Among the reference points shown in FIG. 1, S2a and S2b corresponds to non-3GPP interfaces. S2a is a reference point which provides reliable, non-3GPP access, related control between PDN GWs, and mobility resources to the user plane. S2b is a reference point which provides related control and mobility resources to the user plane between ePDG and PDN GW.

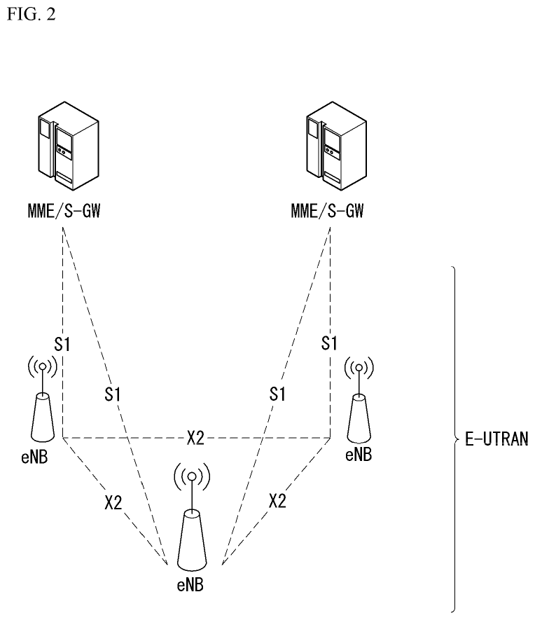

FIG. 2 illustrates one example of an Evolved Universal Terrestrial Radio Access Network (E-UTRAN) to which the present invention may be applied.

The E-UTRAN system is an evolved version of the existing UTRAN system, for example, and is also referred to as 3GPP LTE/LTE-A system. Communication network is widely deployed in order to provide various communication services such as voice (e.g., Voice over Internet Protocol (VoIP)) through IMS and packet data.

Referring to FIG. 2, E-UMTS network includes E-UTRAN, EPC and one or more UEs. The E-UTRAN includes eNBs that provide control plane and user plane protocol, and the eNBs are interconnected with each other by means of the X2 interface.

The X2 user plane interface (X2-U) is defined among the eNBs. The X2-U interface provides non-guaranteed delivery of the user plane Packet Data Unit (PDU). The X2 control plane interface (X2-CP) is defined between two neighboring eNBs. The X2-CP performs the functions of context delivery between eNBs, control of user plane tunnel between a source eNB and a target eNB, delivery of handover-related messages, uplink load management, and so on.

The eNB is connected to the UE through a radio interface and is connected to the Evolved Packet Core (EPC) through the S1 interface.

The S1 user plane interface (S1-U) is defined between the eNB and the Serving Gateway (S-GW). The S1 control plane interface (S1-MME) is defined between the eNB and the Mobility Management Entity (MME). The S1 interface performs the functions of EPS bearer service management, non-access stratum (NAS) signaling transport, network sharing, MME load balancing management, and so on. The S1 interface supports many-to-many-relation between the eNB and the MME/S-GW.

The MME may perform various functions such as NAS signaling security, Access Stratum (AS) security control, Core Network (CN) inter-node signaling for supporting mobility between 3GPP access network, IDLE mode UE reachability (including performing paging retransmission and control), Tracking Area Identity (TAI) management (for UEs in idle and active mode), selecting PDN GW and SGW, selecting MME for handover of which the MME is changed, selecting SGSN for handover to 2G or 3G 3GPP access network, roaming, authentication, bearer management function including dedicated bearer establishment, Public Warning System (PWS) (including Earthquake and Tsunami Warning System (ETWS) and Commercial Mobile Alert System (CMAS), supporting message transmission and so on.

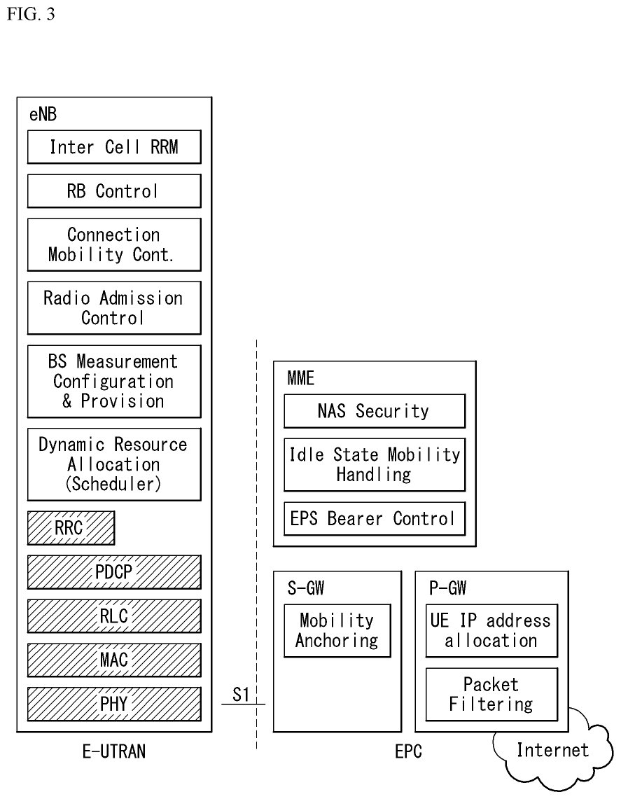

FIG. 3 exemplifies a structure of E-UTRAN and EPC in a wireless communication system to which the present invention may be applied.

Referring to FIG. 3, an eNB may perform functions of selecting gateway (e.g., MME), routing to gateway during radio resource control (RRC) is activated, scheduling and transmitting broadcast channel (BCH), dynamic resource allocation to UE in uplink and downlink, mobility control connection in LTE_ACTIVE state. As described above, the gateway in EPC may perform functions of paging origination, LTE_IDLE state management, ciphering of user plane, bearer control of System Architecture Evolution (SAE), ciphering of NAS signaling and integrity protection.

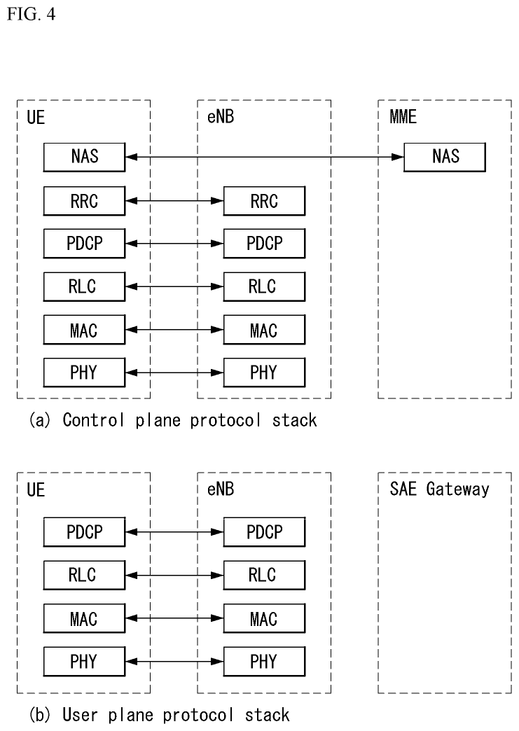

FIG. 4 illustrates a radio interface protocol structure between a UE and an E-UTRAN in a wireless communication system to which the present invention may be applied.

FIG. 4(a) illustrates a radio protocol structure for the control plane, and FIG. 4(b) illustrates a radio protocol structure for the user plane.

Referring to FIG. 4, layers of the radio interface protocol between the UE and the E-UTRAN may be divided into a first layer (L1), a second layer (L2), and a third layer (L3) based on the lower three layers of the Open System Interconnection (OSI) model, widely known in the technical field of communication systems. The radio interface protocol between the UE and the E-UTRAN consists of the physical layer, data link layer, and network layer in the horizontal direction, while in the vertical direction, the radio interface protocol consists of the user plane, which is a protocol stack for delivery of data information, and the control plane, which is a protocol stack for delivery of control signals.

The control plane acts as a path through which control messages used for the UE and the network to manage calls are transmitted. The user plane refers to the path through which the data generated in the application layer, for example, voice data, Internet packet data, and so on are transmitted. In what follows, described will be each layer of the control and the user plane of the radio protocol.

The physical layer (PHY), which is the first layer (L1), provides information transfer service to upper layers by using a physical channel. The physical layer is connected to the Medium Access Control (MAC) layer located at the upper level through a transport channel through which data are transmitted between the MAC layer and the physical layer. Transport channels are classified according to how and with which features data are transmitted through the radio interface. And data are transmitted through the physical channel between different physical layers and between the physical layer of a transmitter and the physical layer of a receiver. The physical layer is modulated according to the Orthogonal Frequency Division Multiplexing (OFDM) scheme and employs time and frequency as radio resources.

A few physical control channels are used in the physical layer. The Physical Downlink Control Channel (PDCCH) informs the UE of resource allocation of the Paging Channel (PCH) and the Downlink Shared Channel (DL-SCH); and Hybrid Automatic Repeat reQuest (HARQ) information related to the Uplink Shared Channel (UL-SCH). Also, the PDCCH may carry a UL grant used for informing the UE of resource allocation of uplink transmission. The Physical Control Format Indicator Channel (PCFICH) informs the UE of the number of OFDM symbols used by PDCCHs and is transmitted at each subframe. The Physical HARQ Indicator Channel (PHICH) carries a HARQ ACK (ACKnowledge)/NACK (Non-ACKnowledge) signal in response to uplink transmission. The Physical Uplink Control Channel (PUCCH) carries uplink control information such as HARQ ACK/NACK with respect to downlink transmission, scheduling request, Channel Quality Indicator (CQI), and so on. The Physical Uplink Shared Channel (PUSCH) carries the UL-SCH.

The MAC layer of the second layer (L2) provides a service to the Radio Link Control (RLC) layer, which is an upper layer thereof, through a logical channel. Also, the MAC layer provides a function of mapping between a logical channel and a transport channel; and multiplexing/demultiplexing a MAC Service Data Unit (SDU) belonging to the logical channel to the transport block, which is provided to a physical channel on the transport channel.

The RLC layer of the second layer (L2) supports reliable data transmission. The function of the RLC layer includes concatenation, segmentation, reassembly of the RLC SDU, and so on. To satisfy varying Quality of Service (QoS) requested by a Radio Bearer (RB), the RLC layer provides three operation modes: Transparent Mode (TM), Unacknowledged Mode (UM), and Acknowledge Mode (AM). The AM RLC provides error correction through Automatic Repeat reQuest (ARQ). Meanwhile, if MAC layer performs the RLC function, the RLC layer may be incorporated into the MAC layer as a functional block.

The Packet Data Convergence Protocol (PDCP) layer of the second layer (L2) performs the function of delivering, header compression, ciphering of user data in the user plane, and so on. Header compression refers to the function of reducing the size of the Internet Protocol (IP) packet header which is relatively large and contains unnecessary control to efficiently transmit IP packets such as the IPv4 (Internet Protocol version 4) or IPv6 (Internet Protocol version 6) packets through a radio interface with narrow bandwidth. The function of the PDCP layer in the control plane includes delivering control plane data and ciphering/integrity protection.

The Radio Resource Control (RRC) layer in the lowest part of the third layer (L3) is defined only in the control plane. The RRC layer performs the role of controlling radio resources between the UE and the network. To this purpose, the UE and the network exchange RRC messages through the RRC layer. The RRC layer controls a logical channel, transport channel, and physical channel with respect to configuration, re-configuration, and release of radio bearers. A radio bearer refers to a logical path that the second layer (L2) provides for data transmission between the UE and the network. Configuring a radio bearer indicates that characteristics of a radio protocol layer and channel are defined to provide specific services; and each individual parameter and operating methods thereof are determined. Radio bearers may be divided into Signaling Radio Bearers (SRBs) and Data RBs (DRBs). An SRB is used as a path for transmitting an RRC message in the control plane, while a DRB is used as a path for transmitting user data in the user plane.

The Non-Access Stratum (NAS) layer in the upper of the RRC layer performs the function of session management, mobility management, and so on.

A cell constituting the base station is set to one of 1.25, 2.5, 5, 10, and 20 MHz bandwidth, providing downlink or uplink transmission services to a plurality of UEs. Different cells may be set to different bandwidths.

Downlink transport channels transmitting data from a network to a UE include a Broadcast Channel (BCH) transmitting system information, PCH transmitting paging messages, DL-SCH transmitting user traffic or control messages, and so on. Traffic or a control message of a downlink multi-cast or broadcast service may be transmitted through the DL-SCH or through a separate downlink Multicast Channel (MCH). Meanwhile, uplink transport channels transmitting data from a UE to a network include a Random Access Channel (RACH) transmitting the initial control message and a Uplink Shared Channel (UL-SCH) transmitting user traffic or control messages.

Logical channels, which are located above the transport channels and are mapped to the transport channels. The logical channels may be distinguished by control channels for delivering control area information and traffic channels for delivering user area information. The control channels include a Broadcast Control Channel (BCCH), a Paging Control Channel (PCCH), a Common Control Channel (CCCH), a dedicated control channel (DCCH), a Multicast Control Channel (MCCH), and etc. The traffic channels include a dedicated traffic channel (DTCH), and a Multicast Traffic Channel (MTCH), etc. The PCCH is a downlink channel that delivers paging information, and is used when network does not know the cell where a UE belongs. The CCCH is used by a UE that does not have RRC connection with network. The MCCH is a point-to-multipoint downlink channel which is used for delivering Multimedia Broadcast and Multicast Service (MBMS) control information from network to UE. The DCCH is a point-to-point bi-directional channel which is used by a UE that has RRC connection delivering dedicated control information between UE and network. The DTCH is a point-to-point channel which is dedicated to a UE for delivering user information that may be existed in uplink and downlink. The MTCH is a point-to-multipoint downlink channel for delivering traffic data from network to UE.

In case of uplink connection between the logical channel and the transport channel, the DCCH may be mapped to UL-SCH, the DTCH may be mapped to UL-SCH, and the CCCH may be mapped to UL-SCH. In case of downlink connection between the logical channel and the transport channel, the BCCH may be mapped to BCH or DL-SCH, the PCCH may be mapped to PCH, the DCCH may be mapped to DL-SCH, the DTCH may be mapped to DL-SCH, the MCCH may be mapped to MCH, and the MTCH may be mapped to MCH.

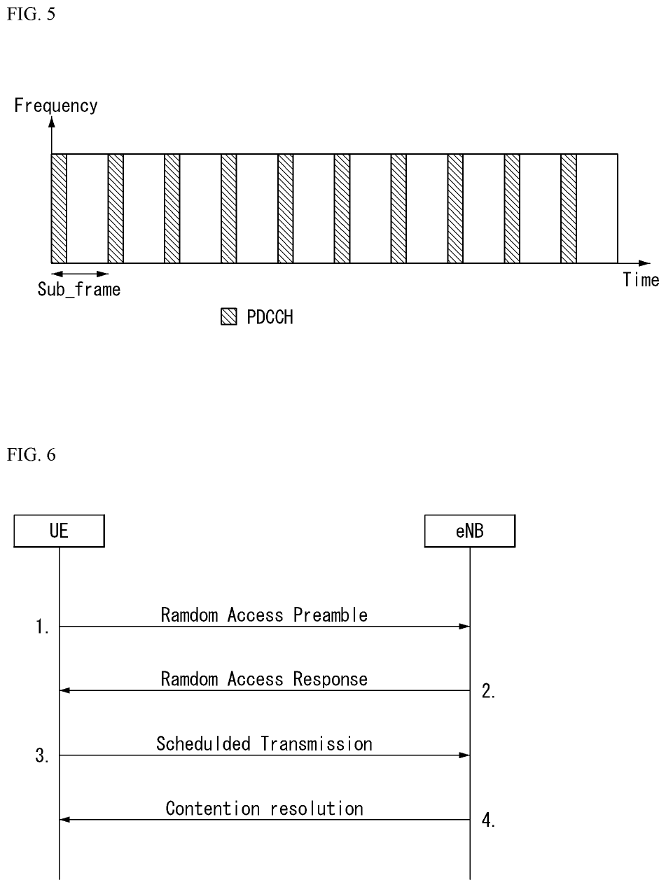

FIG. 5 is a diagram schematically exemplifying a structure of physical channel in a wireless communication system to which the present invention may be applied.

Referring to FIG. 5, the physical channel delivers signaling and data through radio resources including one or more subcarriers in frequency domain and one or more symbols in time domain.

One subframe that has a length of 1.0 ms includes a plurality of symbols. A specific symbol (s) of subframe (e.g., the first symbol of subframe) may be used for PDCCH. The PDCCH carries information for resources which are dynamically allocated (e.g., resource block, modulation and coding scheme (MCS), etc.).

Random Access Procedure

Hereinafter, a random access procedure which is provided in a LTE/LTE-A system will be described.

The random access procedure is performed in case that the UE performs an initial access in a RRC idle state without any RRC connection to an eNB, or the UE performs a RRC connection re-establishment procedure, etc.

The LTE/LTE-A system provides both of the contention-based random access procedure that the UE randomly selects to use one preamble in a specific set and the non-contention-based random access procedure that the eNB uses the random access preamble that is allocated to a specific UE.

FIG. 6 is a diagram for describing the contention-based random access procedure in the wireless communication system to which the present invention may be applied.

(1) Message 1 (Msg 1)

First, the UE randomly selects one random access preamble (RACH preamble) from the set of the random access preamble that is instructed through system information or handover command, selects and transmits physical RACH (PRACH) resource which is able to transmit the random access preamble.

The eNB that receives the random access preamble from the UE decodes the preamble and acquires RA-RNTI. The RA-RNTI associated with the PRACH to which the random access preamble is transmitted is determined according to the time-frequency resource of the random access preamble that is transmitted by the corresponding UE.

(2) Message 2 (Msg 2)

The eNB transmits the random access response that is addressed to RA-RNTI that is acquired through the preamble on the Msg 1 to the UE. The random access response may include RA preamble index/identifier, UL grant that informs the UL radio resource, temporary cell RNTI (TC-RNTI), and time alignment command (TAC). The TAC is the information indicating a time synchronization value that is transmitted by the eNB in order to keep the UL time alignment. The UE renews the UL transmission timing using the time synchronization value. On the renewal of the time synchronization value, the UE renews or restarts the time alignment timer. The UL grant includes the UL resource allocation that is used for transmission of the scheduling message to be described later (Message 3) and the transmit power command (TPC). The TCP is used for determination of the transmission power for the scheduled PUSCH.

The UE, after transmitting the random access preamble, tries to receive the random access response of its own within the random access response window that is instructed by the eNB with system information or handover command, detects the PDCCH masked with RA-RNTI that corresponds to PRACH, and receives the PDSCH that is indicated by the detected PDCCH. The random access response information may be transmitted in a MAC packet data unit and the MAC PDU may be delivered through PDSCH.

The UE terminates monitoring of the random access response if successfully receiving the random access response having the random access preamble index/identifier same as the random access preamble that is transmitted to the eNB. Meanwhile, if the random access response message has not been received until the random access response window is terminated, or if not received a valid random access response having the random access preamble index same as the random access preamble that is transmitted to the eNB, it is considered that the receipt of random access response is failed, and after that, the UE may perform the retransmission of preamble.

(3) Message 3 (Msg 3)

In case that the UE receives the random access response that is effective with the UE itself, the UE processes the information included in the random access response respectively. That is, the UE applies TAC and stores TC-RNTI. Also, by using UL grant, the UE transmits the data stored in the buffer of UE or the data newly generated to the eNB.

In case of the initial access of UE, the RRC connection request that is delivered through CCCH after generating in RRC layer may be transmitted with being included in the message 3. In case of the RRC connection reestablishment procedure, the RRC connection reestablishment request that is delivered through CCCH after generating in RRC layer may be transmitted with being included in the message 3. Additionally, NAS access request message may be included.

The message 3 should include the identifier of UE. There are two ways how to include the identifier of UE. The first method is that the UE transmits the cell RNTI (C-RNTI) of its own through the UL transmission signal corresponding to the UL grant, if the UE has a valid C-RNTI that is already allocated by the corresponding cell before the random access procedure. Meanwhile, if the UE has not been allocated a valid C-RNTI before the random access procedure, the UE transmits including unique identifier of its own (for example, SAE temporary mobile subscriber identity (S-TMSI) or random number). Normally the above unique identifier is longer that C-RNTI.

If transmitting the data corresponding to the UL grant, the UE initiates a contention resolution timer.

(4) Message 4 (Msg 4)

The eNB, in case of receiving the C-RNTI of corresponding UE through the message 3 from the UE, transmits the message 4 to the UE by using the received C-RNTI. Meanwhile, in case of receiving the unique identifier (that is, S-TMSI or random number) through the message 3 from the UE, the eNB transmits the 4 message to the UE by using the TC-RNTI that is allocated from the random access response to the corresponding UE. For example, the 4 message may include the RRC connection setup message.

The UE waits for the instruction of eNB for collision resolution after transmitting the data including the identifier of its own through the UL grant included the random access response. That is, the UE attempts the receipt of PDCCH in order to receive a specific message. There are two ways how to receive the PDCCH. As previously mentioned, in case that the message 3 transmitted in response to the UL grant includes C-RNTI as an identifier of its own, the UE attempts the receipt of PDCCH using the C-RNTI of itself, and in case that the above identifier is the unique identifier (that is, S-TMSI or random number), the UE tries to receive PDCCH using the TC-RNTI that is included in the random access response. After that, in the former case, if the PDCCH is received through the C-RNTI of its own before the contention resolution timer is terminated, the UE determines that the random access procedure is performed and terminates the procedure. In the latter case, if the PDCCH is received through the TC-RNTI before the contention resolution timer is terminated, the UE checks on the data that is delivered by PDSCH, which is addressed by the PDCCH. If the content of the data includes the unique identifier of its own, the UE terminates the random access procedure determining that a normal procedure has been performed. The UE acquires C-RNTI through the 4 message, and after that, the UE and network are to transmit and receive a UE-specific message by using the C-RNTI.

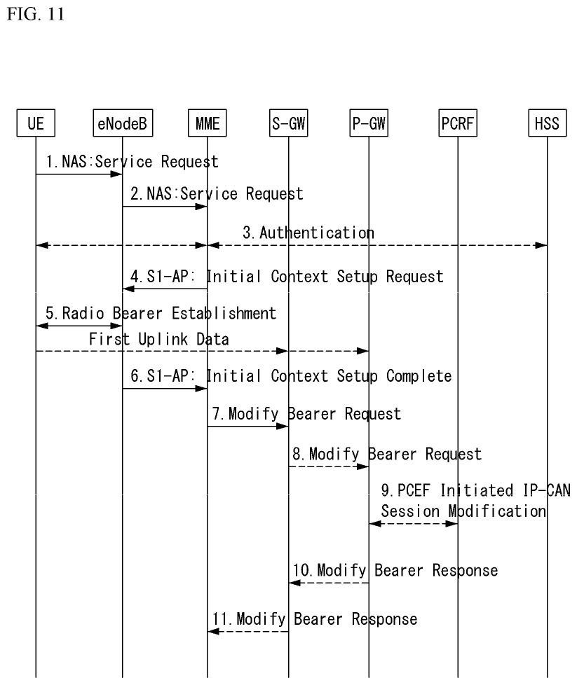

Meanwhile, the operation of the non-contention-based random access procedure, unlike the contention-based random access procedure illustrated in FIG. 11, is terminated with the transmission of message 1 and message 2 only. However, the UE is going to be allocated a random access preamble from the eNB before transmitting the random access preamble to the eNB as the message 1. And the UE transmits the allocated random access preamble to the eNB as the message 1, and terminates the random access procedure by receiving the random access response from the eNB.

Terms used in this specification are described below.
Dedicated bearer: an EPS bearer associated with an uplink packet filter(s) within a UE and a downlink packet filter(s) within a P-GW. In this case, only a specific packet is matched with the filter(s).
Default bearer: an EPS bearer established even new PDN connection. Context of a default bearer is maintained during the lifetime of a PDN connection.
EPS mobility management (EMM)-EMM-NULL state: an EPS service within a UE is deactivated. Any EPS mobility management function is not performed.
EMM-DEREGISTERED state: in the EMM-DEREGISTERED state, EMM context is not established and an MME is not notified of a UE location. Accordingly, the UE is unreachable by the MME. In order to establish EMM context, the UE needs to start an Attach or combined Attach procedure.
EMM-REGISTERED state: In the EMM-REGISTERED state, EMM context within a UE has been established and default EPS bearer context has been activated. When a UE is in the EMM-IDLE mode, an MME is notified of a UE location with accuracy of a list of TAs including a specific number of a TA. The UE may initiate the transmission and reception of user data and signaling information and may respond to paging. Furthermore, a TAU or combined TAU procedure is performed.
EMM-CONNECTED mode: when an NAS signaling connection is set up between a UE and a network, the UE is the EMM-CONNECTED mode. The term “EMM-CONNECTED” may be referred to as a term “ECM-CONNECTED state.”
EMM-IDLE mode: when an NAS signaling connection is not present between a UE and a network (i.e., an EMM-IDLE mode without suspend indication) or RRC connection suspend is indicated by a lower layer (i.e., an EMM-IDLE mode with suspend indication), the UE is in the EMM-IDLE mode. The term “EMM-IDLE” may be referred to as a term “ECM-IDLE state.”
EMM context: when an Attach procedure is successfully completed, EMM context is established between a UE and an MME.
Control plane CIoT EPS optimization: signaling optimization that enables the efficient transport of user data (IP, non-IP or SMS) through a control plane via an MME. This may optionally include the header compression of IP data.
User plane CIoT EPS optimization: signaling optimization that enables the efficient transport of user data (IP or non-IP) through a user plane.
EPS service(s): a service(s) provided by a PS domain.
NAS signaling connection: a peer-to-peer S1 mode connection between a UE and an MME. An NAS signaling connection has a concatenation of an RRC connection via an LTE-Uu interface and an S1AP connection via an S1 interface.
UE using EPS services with control plane CIoT EPS optimization: UE attached for EPS services with control plane CIOT EPS optimization approved by a network
Non-access stratum (NAS): a functional layer for exchanging an UMTS, signaling between a UE and a core network in an EPS protocol stack, and a traffic message. This has a main function of supporting the mobility of a UE and supporting a session management procedure of establishing and maintaining an IP connection between a UE and a PDN GW.
Access stratum (AS): this means a protocol layer under the NAS layer on the interface protocol between an E-UTRAN (eNB) and a UE or between an E-UTRAN (eNB) and an MME. For example, in the control plane protocol stack, the RRC layer, PDCP layer, RLC layer, MAC layer and PHY layer may be collectively referred to as an AS layer or any one of the layers may be referred to as an AS layer. Or, in the user plane protocol stack, the PDCP layer, RLC layer, MAC layer and PHY layer may be collectively referred to as an AS layer or any one of the layers may be referred to as an AS layer.
S1 mode: a mode applied to a system having functional separation according to the use of an S1 interface between a radio access network and a core network. The S1 mode includes a WB-S1 mode and an NB-S1 mode.
NB-S1 mode: this mode is applied by a UE when a serving radio access network of the UE provides access to a network service (via E-UTRA) based on a narrow band (NB)-Internet of things (IoT).
WB-S1 mode: this mode is applied when a system operates in the S1 mode, but is not the NB-S1 mode.

In 3GPP Release 14, service requirements are being worked in SA1 so that non-public safety UEs receives a network connection service through a relay UE. As a UE receiving the network connection service through the relay UE, a wearable device is representatively considered.

Even in SA2 and RAN WG, each of FS_REAR (a remote UE connection through the relay UE) and F2D2D (enhancement of LTE device to device communication and a relay between a UE and a network for Internet of things (IoT) and wearables) as a study item description (SID) for a release (Rel)-13 relay is approved and a study related thereto is in progress.

Characteristically, an F2D2D study item is under discussion to target low power, low rate, and low complexity/low cost devices.

In addition, in an FS_REAR study item, it is discussed whether a common solution for asymmetric uplink/downlink connection (i.e., uplink transmission through the PC5 and direct downlink transmission through Uu with an enhanced ProSe UE-to-Network Relay) and symmetric uplink/downlink connection is available.

As described above, two cases, i.e., asymmetric uplink/downlink and symmetric uplink/downlink are considered.

Here, the ‘asymmetric uplink/downlink’ refers to a case where the remote UE uses a direct link with the relay UE for the uplink transmission and a Uu interface from an eNB for downlink transmission.

The ‘symmetric uplink/downlink’ refers to a case where the remote UE uses the direct link with the relay UE for both uplink and downlink transmissions.

Hereinafter, the present invention proposes a method for transmitting and receiving, by the remote UE, small data through the relay UE.

One-to-One Proximity-Based Services (ProSe) Direct Communication and PC5 Signaling Procedures/Messages

Hereinafter, a PC5 (i.e., UE-to-UE radio interface) signaling protocol procedure between two ProSe-enabled UEs for the one-to-one ProSe direct communication will be described.

The following PC5 signaling protocol procedure is defined:
Direct link setup;
Direct link keepalive;
Direct link release; and
Direct link authentication.

The UE should be authenticated for the one-to-one ProSe direct communication and acquire a ProSe direct communication policy parameter based on a service authentication procedure before initiating or participating in any PC5 signaling protocol procedure for the one-to-one ProSe direct communication.

The UE selects a radio resource for the one-to-one ProSe direct communication.

For one-to-one communication between the remote UE and a ProSe UE-to-network relay UE, when the remote UE receives a lower layer indication that the use of a radio resource for relay communication is not permitted, the remote UE stops an ongoing procedure (i.e., PC5 signaling protocol procedure and data transmission/reception) involving the relay. In addition, the remote UE starts a specific timer having a T value. While the timer is running, the remote UE does not initiate any procedure involving the relay. When the remote UE receives a lower layer indication that the use of the radio resource for the relay communication is permitted, the remote UE may stop the specific timer and resume the procedure involving the relay. Otherwise, after the specific timer expires, the remote UE locally releases all direct links for communication with the relay(s).

1. Direct Link Setup Procedure

Hereinafter, the direct link setup procedure for setting up the direct link will be described. According to contents to be described below, the remote UE transmits a direct communication request (REQUEST_COMMUNICATION_REQUEST) message to the relay UE in order to set up the direct link. The DIRECT_COMMUNICATION_REQUEST message contains parameters required for setting up the direct link.
IP Address Config IE or Link Local IPv6 Address IE is a parameter required for assignment of an IP address of the remote UE.
The following are security related parameters for establishing a secure connection and authenticating the direct link.

Nonce_1 IE, UE Security Capabilities, Most Significant Bit (MSB) of KD-Sess ID, KD ID, and Signature

According to contents to be described below, when the relay UE receiving the DIRECT_COMMUNICATION_REQUEST message successfully completes confirmation of user information and an IP configuration, the UE performs a direct security mode control procedure in order to establish a security association with the remote UE.

1) General

The direct link setup procedure is used for establishing a safe direct link between two ProSe-enabled UEs. A UE that transmits the request message is referred to as “initiating UE” and the other UE is referred to as “target UE”.

When the direct link setup is for isolated one-to-one ProSe direct communication (i.e., when both UEs are not the ProSe UE-to-network relays), both UEs are required to obtain a set of qualifications associated with a public key of a key management server (KMS) and an identifier of the UE in advance.

2) Initiating Direct Link Setup Procedure by Initiating UE

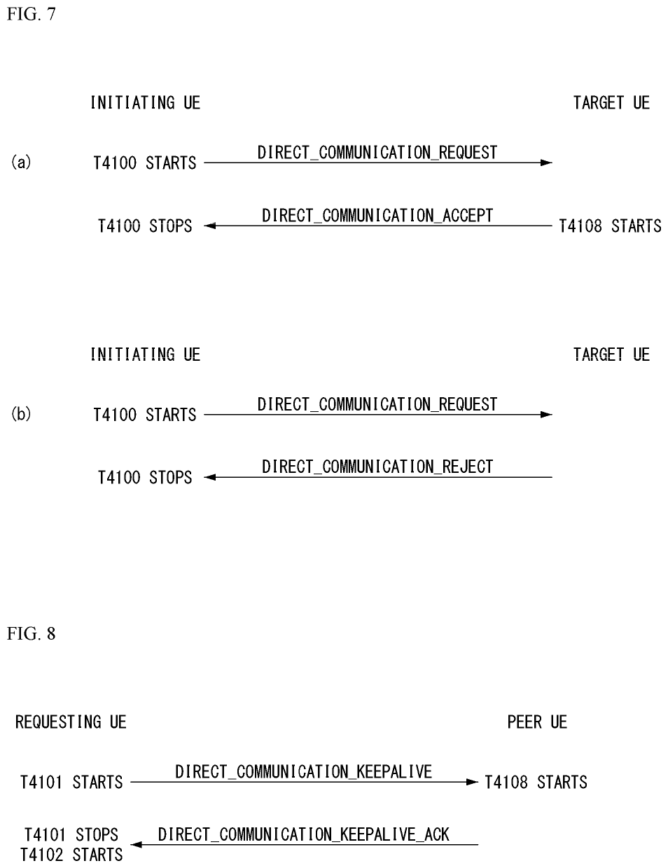

FIG. 7 illustrates a direct link setup procedure in the wireless communication system to which the present invention may be applied.

The initiating UE needs to satisfy the following pre-conditions before initiating such a procedure:
a request is received from an upper layer for establishing the direct link with a target UE and a link between the initiating UE and the corresponding target UE is not present;
a link layer identifier (i.e., layer 2 ID used for unicast communication) for the initiating UE is available (e.g., pre-configured or self-assigned);
a link layer identifier (i.e., layer 2 ID used for unicast communication) for the target UE is available for the initiating UE (e.g., pre-configured or acquired through ProSe direct discovery); and
the initiating UE is authenticated for ProSe direct communication in serving PLMN or has a valid authentication for the ProSe direct communication when is not served by E-UTRAN.

The initiating UE generates the direct communication request (DIRECT_COMMUNICATION_REQUEST) message to initiate the direct link setup procedure.

In this case, the DIRECT_COMMUNICATION_REQUEST message includes the following.

i) User information (User Info) set as follows:
User Info of the initiating UE, which is received from the upper layer when the target UE is not the ProSe UE-to-network relay UE;
ProSe relay user key ID received from a ProSe Key Management Function (PKMF) when the target UE is the ProSe UE-to-network relay UE and the initiating UE receives PRUK for the relay from the PKMF and a connection attempt to the relay is not rejected because a PRUK ID is not recognized;
IMSI of the initiating UE when the target UE is the ProSe UE-to-network relay UE and the initiating UE does not receive the PRUK from the PKMF for the relay; or
IMSI of the initiating UE when the target UE is the ProSe UE-to-network relay UE and the initiating UE receives the PRUK from the PKMF for the relay, but the connection attempt to the relay is rejected because the PRUK ID is not recognized;

ii) Internet protocol (IP) address config information element (IE) set to one value of the following values:
when an IP version 4 (IPv4) address allocation mechanism is supported by the initiating UE, that is, the IP version 4 (IPv4) address allocation mechanism operates as a Dynamic Host Configuration Protocol version 4 (DHCPv4), “DHCPv4 server”;
when an IP version 6 (Ipv6) address allocation mechanism is supported by the initiating UE, that is, the IP version 6 (Ipv6) address allocation mechanism operates as an Ipv6 router, “IPv6 router”;
when both IPv4 and IPv6 address allocation mechanisms are supported by the initiating UE, “DHCPv4 server and IPv6 router”; or
when both IPv4 and IPv6 address allocation mechanisms are not supported by the initiating UE, “address allocation not supported”;

iii) when the IP Address Config IE is set to “address allocation not supported” and the link is set up for isolated one-to-one communication, link local address (Link Local IPv6 Address) IE locally formed based on Internet Engineering Task Force (IETF) Request for Comments (RFC) 4862;

iv) Maximum Inactivity Period IE indicating a maximum inactivity period of a requesting UE through the direct link;

v) Nonce_1 IE set to 128-bit nonce value generated by the initiating UE for establishing a session key through the direct link;

vi) UE Security Capabilities IE set to indicate a list of algorithms which the initiating UE supports for establishing security of the direct link;

vii) MSB of K_D-sess ID IE set to most significant 8 bits of K_D-sess identifier (ID); and

viii) optionally, when the initiating UE has the existing K_D with the target UE, K_D ID IE set to known ID of K_D established previously.

When the direct link setup is for the isolated one-to-one ProSe direct communication, the DIRECT_COMMUNICATION_REQUEST message also includes the following parameter:
Signature IE set to Elliptic Curve-Based Certificateless Signatures for Identity-Based Encryption (ECCSI) signature calculated by User Info IE and Nonce_1 IE.

Otherwise, when the link setup is for ProSe direct communication to the ProSe UE-to-network relay, the DIRECT_COMMUNICATION_REQUEST message includes a Relay Service Code IE set to a relay service code of a target relay.

After the DIRECT_COMMUNICATION_REQUEST message is generated, the initiating UE transports the message to the lower layer together with layer 2 ID (for unicast communication) of the initiating UE and layer 2 ID (for unicast communication) of the target UE for transmitting the message and starts a T4100 timer. The UE does not transmit a new DIRECT_COMMUNICATION_REQUEST message to the same target UE while the T4100 timer is running.

3) Direct Link Setup Procedure Accepted by Target UE

Referring to FIG. 7(a), when receiving the DIRECT_COMMUNICATION_REQUEST message, the target UE stores a pair (for unicast communication) of layer 2 IDs used in transport of the message provided by the lower layer and associates the pair of layer 2 IDs with a direct link context.

The target UE checks the User Info IE included in the DIRECT_COMMUNICATION_REQUEST message and determines whether the request is to be accepted. In addition, the target UE checks IP Address Config IE in order to check whether at least one common IP address configuration option is supported by both the initiating UE and the target UE. When all checks described above are successful, the target UE calls the direct security mode control procedure in order to establish a security association between the target UE and the initiating UE. After completion of the link authentication procedure and successful establishment of the security association, the target UE transmits a direct communication accept (DIRECT_COMMUNICATION_ACCEPT) message to the initiating UE.

The target UE encapsulates the IP Address Config IE set to one of the following values:
when the IPv4 address allocation mechanism is supported by the target UE and the target UE may operate as the DHCP server, “DHCPv4 Server”;
when the IPv6 address allocation mechanism is supported by the target UE and the target UE may operate as the IPv6 router, “IPv6 Router”;
when both IPv4 and IPv6 address allocation mechanisms are supported by the target UE, “DHCPv4 server and IPv6 router”; or
when both IPv4 and IPv6 address allocation mechanisms are not supported by the target UE, “address allocation not supported”.

When the IP Address Config IE is set to “address allocation not supported” and the received DIRECT_COMMUNICATION_REQUEST message contains the Link Local IPv6 Address IE, the target UE encapsulates the Link Local IPv6 Address IE set to the locally formed link local IPv6 address.

The ProSe UE-to-network relay UE supports at least one IP address allocation mechanism.

In the case where the target UE operates as the ProSe UE-to-network relay UE and the PDN connection for the relay associated with the ProSe relay UE ID is not yet established or an additional PDN connection used for the relay is required when the ProSe UE-to-network relay UE transmits the DIRECT_COMMUNICATION_ACCEPT message to the remote UE, the ProSe UE-to-network relay UE transmits a PDN CONNECTIVITY REQUEST message including an APN associated with the ProSe Relay UE ID to initiate a UE-requested PDN connectivity procedure.

When the target UE is the ProSe-UE-to-network relay UE, the target UE generates an inactivity timer T4108 with the value provided by the Maximum Inactivity Period IE included in the DIRECT_COMMUNICATION_REQUEST message and when there is no more message to be transmitted via the link to be established, the target UE starts the T4108 timer. In the case where the T4108 timer is started, when any communication activity occurs before the T4108 timer expires, the UE terminates the T4108 timer and resets the T4108 timer to an initial value, otherwise a new value is provided in the Maximum Inactivity Period IE in the DIRECT_COMMUNICATION_KEEPALIVE message.

In the case where the target UE is the ProSe-UE-to-network relay UE and the target UE is configured to report an International Mobile Station Equipment Identity (IMEI) or IMEISV of the remote UE(s) served by the relay based on a service authorization procedure by a serving PLMN, the ProSe UE-to-network relay UE initiates a remote UE information request procedure in order to request the IMEI or IMEISV of the remote UE when the direct link is successfully established.

4) Completion of Direct Link Setup Procedure by Initiating UE

Upon receiving the DIRECT_COMMUNICATION_ACCEPT, the initiating UE stops the T4100 timer. From this time, the initiating UE uses the established link for all one-to-one communications (including additional PC5 signaling messages) to the target UE.

5) Direct Link Setup Procedure not Accepted by Target UE

Referring to FIG. 7(b), WHEN the direct link setup request may not be accepted, the target UE transmits a DIRECT_COMMUNICATION_REJECT message. The DIRECT_COMMUNICATION_REJECT message contains a PC5 signaling protocol cause value set to one of the following cause values:

#1 Direct communication to target UE not allowed;

#2 Authentication failure;

#3 Conflict of Layer 2 ID for unicast communication is detected;

#4 Lack of resources for proposed link;

#5 IP version mismatch; or

#6 Link setup failure due to other errors.

When the target UE is not permitted to accept such a request (for example, based on an operator policy or service permission provisioning), the target UE transmits the DIRECT_COMMUNICATION_REJECT message including the PC5 signaling protocol cause value #1 “Direct communication to target UE not allowed”.

When the target UE fails in verification of signature parameters included in the DIRECT_COMMUNICATION_REQUEST, the target UE transmits the DIRECT_COMMUNICATION_REJECT message including the PC5 signaling protocol cause value #2 “Authentication failure”.

When the target UE fails in the direct link setup due to a problem in the direct link permission procedure, the target UE transmits the DIRECT_COMMUNICATION_REJECT message including the PC5 signaling protocol cause value #2 “Authentication failure”.

For the Layer 2 ID of the received DIRECT_COMMUNICATION_REQUEST message, when the target UE has an established existing link to the UE that already uses the Layer 2 ID, which is known by the target UE or when the target UE is currently processing the DIRECT_COMMUNICATION_REQUEST message from the same Layer 2 ID, but has User Info different from User Info IE included in a newly received message, the target UE transmits the DIRECT_COMMUNICATION_REJECT message including the PC5 signaling protocol cause value #3 “Conflict of Layer 2 ID for unicast communication is detected”.

When the direct link setup is unsuccessful due to other transient lower layer problems causing congestion problems or resource limitations, the target UE transmits the DIRECT_COMMUNICATION_REJECT message including the PC5 signaling protocol cause value #4 “Lack of resources for proposed link”.

In the case of the ProSe UE-to-network relay UE, the remote UE desires to use the ProSe UE-to-network relay UE with respect to mission critical communication (e.g., Mission Critical Push To Talk (MCPTT), but when the ProSe UE-to-network relay UE does not support the IPv6 address allocation scheme as the router, the target UE (i.e., ProSe UE-to-network relay UE) transmits the DIRECT_COMMUNICATION_REJECT message including the PC5 signaling protocol cause value #5 “IP version mismatch”.

For other reasons causing the link establishment failure, the target UE transmits the DIRECT_COMMUNICATION_REJECT message including the PC5 signaling protocol cause value #6 “Link setup failure due to other errors”.

Upon receiving the DIRECT_COMMUNICATION_REJECT message, the initiating UE stops the T4100 timer and terminates the direct link setup procedure. When the cause value in the DIRECT_COMMUNICATION_REJECT message is #1 “Direct communication to target UE not allowed” or #4 “Lack of resources for proposed link”, the UE does not attempt to set up the direct link with the same target UE for at least a time period T. In addition, when the initiating UE is the remote UE that requests the link setup to the ProSe UE-to-network relay UE, the initiating UE initiates a relay reselection procedure.

When it is no longer necessary to establish the link before such a procedure is completed, the initiating UE terminates the procedure.

When the Layer 2 ID of the received DIRECT_COMMUNICATION_REQUEST message includes the same User Info as a user that knows a new request with the established existing link to the UE that already uses the Layer 2 ID, which is known by the target UE, the UE performs the new request. However, the target UE deletes the existing link context after a new link setup procedure is successful or after the link keepalive procedure is unsuccessful.

6) Abnormal Case

When the inactivity timer T4108 expires and the target UE is the ProSe UE-to-network relay UE, the target UE initiates the direct link release procedure due to release cause #3 “Direct connection is not available any more”. Otherwise, the target UE may operate as follows:

A) The target UE initiates a keepalive procedure to check the link; or

B) The target UE initiates release cause #3 “Direct connection is not available any more”.

7) PC5_Signaling Message Related to Direct Link Setup Procedure

i) DIRECT_COMMUNICATION_REQUEST

The message is transmitted by the UE to another peer UE to establish the direct link.

Table 2 shows the DIRECT_COMMUNICATION_REQUEST message.

TABLE 2

| IEI | Information element | Type/Reference | Presence | Format | Length |
|---|---|---|---|---|---|
| | DIRECT_COMMUNICATION_REQUEST | PC5-SP message type | M | V | 1 |
| | message identity | TS 24.334 12.5.1.1. | | | |
| | Sequence Number | Sequence Number | M | V | 2 |
| | | TS 24.334 12.5.1.2 | | | |
| | User Info | User Info | M | LV | 3-253 |
| | | TS 24.334 12.5.1.3 | | | |
| | IP Address Config | IP Address Config | M | V | 1 |
| | | TS 24.334 12.5.1.4 | | | |
| | Maximum Inactivity Period | Maximum Inactivity Period | M | V | 4 |
| | | TS 24.334 12.5.1.9 | | | |
| | Nonce_1 | Nonce_1 | M | V | 16 |
| | | TS 24.334 12.5.1.30 | | | |
| | UE Security Capabilities | UE Security Capabilities | M | V | 2 |
| | | TS 24.334 12.5.1.22 | | | |
| | MSB of K_D-sess ID | MSB of KD-sess ID | M | V | 1 |
| | | TS 24.334 12.5.1.25 | | | |
| 17 | K_D ID | KD ID | O | TV | 5 |
| | | TS 24.334 12.5.1.30 | | | |
| 25 | Relay Service Code | Relay Service Code | O | TV | 4 |
| | | TS 24.334 12.5.1.17 | | | |
| 22 | Signature | Signature | O | TV | 130 |
| | | TS 24.334 12.5.1.33 | | | |
| 3 | Link Local IPv6 Address | IPv6 Address | O | TV | 17 |
| | | TS 24.334 12.5.1.5 | | | |

In Table 2, the information element represents a name of the information element. ‘M’ in a Presence field as a mandatory represents an IE included in the message, and ‘0’ as an optional IE represents an IE that may be included in the message or not included in the message, and ‘C’ represents as a conditional IE represents an IE included in the message only when a specific condition is satisfied.

ii) DIRECT_COMMUNICATION_ACCEPT

The message is transmitted by the UE to another peer UE to indicate that the corresponding direct link setup request is accepted.

Table 3 shows the DIRECT_COMMUNICATION_ACCEPT message.

TABLE 3

| IEI | Information element | Type/Reference | Presence | Format | Length |
|---|---|---|---|---|---|
| | DIRECT_COMMUNICATION_ACCEPT | PC5-SP message type | M | V | 1 |
| | message identity | TS 24.334 12.5.1.1. | | | |
| | Sequence Number | Sequence Number | M | V | 2 |
| | | TS 24.334 12.5.1.2 | | | |
| | IP Address Config | IP Address Config | M | V | 1 |
| | | TS 24.334 12.5.1.4 | | | |
| 3 | Link Local IPv6 Address | Link Local IPv6 Address | O | TV | 17 |
| | | TS 24.334 12.5.1.5 | | | |

In Table 3, when the IP Address Config IE is set to “address allocation not supported UE”, the UE encapsulates the Link Local IPv6 Address IE.

iii) DIRECT_COMMUNICATION_REJECT

The message is transmitted by the UE to another peer UE to indicate that the corresponding direct link setup request is rejected.

Table 4 shows the DIRECT_COMMUNICATION_REJECT message.

TABLE 4

| IEI | Information element | Type/Reference | Presence | Format | Length |
|---|---|---|---|---|---|
| | DIRECT_COMMUNICATION_REJECT | PC5-SP message type | M | V | 1 |
| | message identity | 12.5.1.1. | | | |
| | Sequence Number | Sequence Number | M | V | 2 |
| | | 12.5.1.2 | | | |
| | PC5 Signalling Cause Value | PC5 Signalling Cause | M | V | 1 |
| | | Value 12.5.1.7 | | | |

2. Direct Link Keepalive Procedure

1) General

The direct link keepalive procedure is used to maintain THE direct link between two ProSe-enabled UEs (i.e., check whether the link between the two UEs is still maintainable). Such a procedure may be initiated by any one UE or both UEs in the established direct link. When the direct link is used for one-to-one communication between the remote UE and the ProSe UE-to-network relay UE, only the remote UE initiates the link keepalive procedure.

Within such a procedure, a UE that transmits the Direct COMMUNICATION_KEEPALIVE message is referred to as the “requesting UE” and the other UE is referred to as the “peer UE”.

2) Initiation of Direct Link Keepalive Procedure by Requesting UE

FIG. 8 is a diagram illustrating a direct link keepalive in a wireless communication system to which the present invention may be applied.

The requesting UE manages a keepalive timer T4102 and a keepalive counter for such a procedure. The keepalive timer T4102 is used to trigger periodic initiation of the procedure. The timer is started or restarted whenever the UE receives a PC5 signaling message or PC5 user plane data from the peer UE over this link. The keepalive counter is set to an initial value of 0 after link establishment.

The requesting UE may initiate this procedure in the following case:
Case of receiving a request from the upper layer so as to check maintainability of the direct link; or
Case where the keepalive timer T4102 for this link expires.

When the timer T4102 is running, the requesting UE stops the timer T4102 and generates the DIRECT_COMMUNICATION_KEEPALIVE message with a keepalive counter to initiate the procedure. Optionally, the initiating UE may encapsulate the Maximum Inactivity Period IE in order to indicate the maximum inactivity period of the requesting UE through the direct link. When the remote UE transmits the DIRECT_COMMUNICATION_KEEPALIVE message to the ProSe UE-to-network relay UE, the IE is included in the DIRECT_COMMUNICATION_KEEPALIVE message.

After the DIRECT_COMMUNICATION_KEEPALIVE message is generated, the requesting UE transports the message to the lower layer together with layer 2 ID (for unicast communication) of the requesting UE and layer 2 ID (for unicast communication) of the peer UE for transmission and starts a retransmission timer T4101.

3) Direct Link Keepalive Procedure Accepted by Peer UE

Upon receipt of the DIRECT_COMMUNICATION_KEEPALIVE message, the peer UE responds with a DIRECT_COMMUNICATION_KEEPALIVE_ACK message containing a Keepalive Counter IE set to a value which is the same as the value received in the DIRECT_COMMUNICATION_KEEPALIVE message.

When the Maximum Inactivity Period IE is included in the DIRECT_COMMUNICATION_KEEPALIVE message, the peer UE stops the inactivity timer T4108 (when the inactivity timer T4108 is running) and restarts the timer T4108 with the provided value. In addition, when any communication activity occurs in this direct link before the timer T4108 expires, the UE stops the timer T4108 and resets the timer T4108 to the initial value.

4) Completion of Direct Link Keepalive Procedure by Requesting UE

Upon receiving the DIRECT_COMMUNICATION_KEEPALIVE_ACK message, the requesting UE stops the retransmission timer T4101, starts the keepalive timer T4102, and increments the keepalive counter for this link.

5) Abnormal Case

When the retransmission timer T4101 expires, the requesting UE retransmits the DIRECT_COMMUNICATION_KEEPALIVE message with a last used keepalive counter value again and restarts the timer T4101. When no response is received from the peer UE until the maximum number of allowed retransmissions is reached, the requesting UE terminates the link keepalive procedure and instead initiates the direct link release procedure. When the requesting UE is the remote UE, the requesting UE initiates the relay reselection procedure.

When the direct link need not be used before the direct link keepalive procedure is completed, the requesting UE terminates the procedure and instead starts the direct link release procedure.

When the inactivity timer T4108 expires and the peer UE is the ProSe UE-to-network relay UE, the peer UE initiates the direct link release procedure due to release cause #3 “Direct connection is not available any more”. Otherwise, the peer UE may operate as follows:

A) The peer UE initiates the keepalive procedure to check the link; or

B) The target UE initiates the direct link due to release cause #3 “Direct connection is not available any more”.

3. Direct Link Release Procedure

1) General

The direct link release procedure is used for releasing the safe direct link between two ProSe-enabled UEs. The link may be released from any one UE of the two UEs. A UE that transmits the DIRECT_COMMUNICATION_RELEASE message is referred to as a “releasing requesting UE” and the other UE is referred to as the “peer UE”.

When the direct link between the remote UE and the ProSe UE-to-network relay UE is released, the ProSe-UE-to-network relay UE performs a Remote UE report procedure.

2) Initiation of Direct Link Release Procedure by Releasing UE

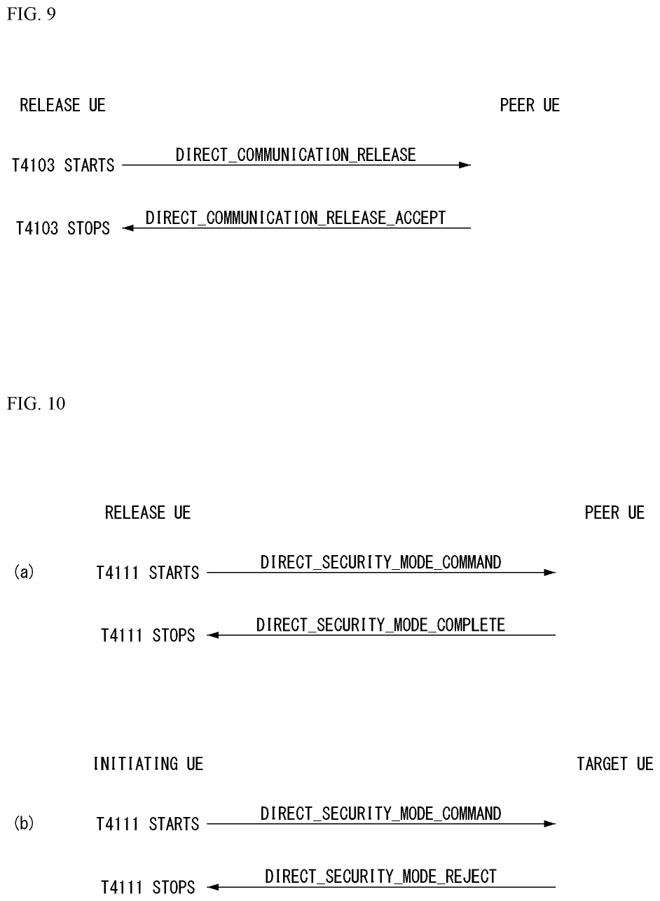

FIG. 9 is a diagram illustrating a direct link release procedure in a wireless communication system to which the present invention may be applied.

The releasing UE initiates the procedure in the following case:
Case where the request is received from the upper layer so as to release the direct link with the peer UE using known Layer 2 ID (for unicast communication) and the link between the corresponding two UEs is present; or
Case where the peer UE is non-responsive (e.g., case where the direct link keepalive procedure may not be completed).

The releasing UE initiates the direct link release procedure by generating an IRECT_COMMUNICATION_RELEASE message with a Release Reason IE indicating one of the following cause values:

#1 Direct Communication to peer UE no longer needed;

#2 Direct communication with the peer UE is no longer allowed; or

#3 Direct connection is not available any more.

After the DIRECT_COMMUNICATION_RELEASE message is generated, the releasing UE transports the message to the lower layer together with layer 2 ID (for unicast communication) of the releasing UE and layer 2 ID (for unicast communication) of the peer UE for transmission. When the release caluse is #3 “Direct connection is not available any more”, the releasing UE locally releases the direct link. Otherwise, the releasing UE starts a timer T4013.

3) Direct Link Release Procedure Accepted by Peer UE

Upon receipt of the DIRECT_COMMUNICATION_RELEASE message, the peer UE stops the timer T4101, the timer T4102, or the timer T4103 for this link (when any timer is running). In addition, the peer UE terminates any ongoing PC5 signaling protocol procedure over this link. The peer UE responds with a DIRECT_COMMUNICATION_RELEASE_ACCEPT message. After this message is sent, the peer UE removes a context of this direct link and does not transmit or receive any message over this link any longer.

When the cause value in the DIRECT_COMMUNICATION_RELEASE message is “Direct communication with the peer UE is no longer allowed”, the UE will not attempt to set up the direct link with the releasing UE for at least a time period T. In addition, when the initiating UE is the remote UE that requests the link setup to the ProSe UE-to-network relay UE, the initiating UE initiates the relay reselection procedure.

4) Completion of Direct Link Release Procedure by Releasing UE

Upon receiving the DIRECT_COMMUNICATION_RELEASE_ACCEPT message, the releasing UE stops the timer T4103. From this time, the releasing UE does not transmit or receive any message through this link any longer.

5) Abnormal Case

When the retransmission timer T4108 expires, the releasing UE transmits the DIRECT_COMMUNICATION_RELEASE message again and restarts the timer T4103. When no response is received from the peer UE until the maximum number of allowed retransmissions is reached, the releasing UE locally releases the direct link. From this time, the releasing UE does not transmit or receive any message through this link any longer.

4. Direct Security Mode Control Procedure

1) General

The security association for the direct link between two ProSe-Enabled UEs is established by exchanging message contents associated with direct security mode establishment during the direct link setup procedure or a direct link rekeying procedure. After the direct security mode control procedure is successfully completed, the selected security algorithm and key are used for integrity protection and encryption of all PC5 signaling messages exchanged between UEs. In addition, the selected security algorithm and key are used for encrypting all data plane traffic exchanged between the UEs.

A UE that transmits a DIRECT_SECURITY_MODE_COMMAND message is referred to as a “commanding UE” and the other UE is referred to as the “peer UE”.

2) Initiation of Direct Security Mode Control Procedure by Commanding UE

FIG. 10 illustrates a direct security mode control procedure in a wireless communication system to which the present invention may be applied.

The commanding UE may initiate a direct security mode control procedure in response to reception of the DIRECT_COMMUNICATION_REQUEST message or the DIRECT_REKEYING_REQUEST message.

When the procedure is performed between the remote UE and the ProSe UE-to-network relay UE and the procedure is triggered by the DIRECT_REKEYING_REQUEST message for refreshing not K_D but K_D-sess, the ProSe UE-commanding UE or the remote UE may operate as the commanding UE. Otherwise, when both K_D and K_D-sess are refreshed, the ProSe UE-to-network relay UE operates as the commanding UE.

In order to initiate this procedure, the commanding UE identifies the existing K_D based on the K_D ID contained in the DIRECT_COMMUNICATION_REQUEST message or the DIRECT_REKEYING_REQUEST message or when the commanding does not share the known K_D with the peer UE, the commanding UE derives a fresh K_D or desires to derive the fresh K_D. In the latter case, the commanding UE generates a Most Significant Bit (MSB) of the K_D ID to ensure that the resulting generated K_D ID is unique within the commanding UE. Then, the commanding UE generates a Least Significant Bit (LSB) of the K_D-sess ID (received within the DIRECT_COMMUNICATION_REQUEST or DIRECT_REKEYING_REQUEST to trigger the direct security mode procedure) so that the K_D-sess ID formed through the combination with the MSB of the K_D-sess ID is unique within the commanding UE.

Next, the commanding UE generates a 128-bit Nonce_2 value. The commanding UE derives the K_D-sess by using K_D, Nonce_2, and Nonce_1 received within the DIRECT_COMMUNICATION_REQUEST or DIRECT_REKEYING_REQUEST message.

In addition, the UE constructs a direct security mode command (DIRECT_SECURITY_MODE_COMMAND) message with the following:
Nonce_2 IE set to Nonce_2;
Least significant bit of K_D-sess ID IE set to indicate least significant 8 bits of K_D-sess ID;
UE Security Capabilities IE set to UE security capabilities received within the DIRECT_COMMUNICATION_REQUEST message or DIRECT_REKEYING_REQUEST message; and
Chosen Algorithms IE set to an algorithm to be used for encryption and integrity protection.

When the DIRECT_SECURITY_MODE_COMMAND message is used between the remote UE and the ProSe UE-to-network relay UE and the ProSe UE-to-network relay UE receives a K_D freshness parameter from the PKMF, the relay UE encapsulates the following additional parameters in the DIRECT_SECURITY_MODE_COMMAND message in order to generate a fresh K_D.
GPI IE including a GBA Push-Info (GPI) payload when being received from the PKMF;
K_D Freshness IE set to the K_D freshness parameter received from the PKMF; and
MSB of KD ID IE set to the MSB of a K_D ID of the fresh K_D.

When the DIRECT_SECURITY_MODE_COMMAND message is used for the isolated one-to-one ProSe direct communication, the commanding UE encapsulates the following additional parameters in the DIRECT_SECURITY_MODE_COMMAND message in order to generate the fresh K_D:
User Info IE set to User Info received from the upper layer;
MSB of KD ID IE set to MSB of the K_D ID of the fresh K_D; and
Signature IE set to an ECCSI signature calculated by User Info IE, Nonce_1 IE, and Encrypted Payload IE set to a Sakai-Kasahara Key Encryption (SAKKE) payload.

The commanding UE chooses an integrity protection and encryption algorithm to be used and optionally encapsulates the chosen algorithm in the Chosen algorithms IE within the DIRECT SECURITY MODE COMMAND message. The commanding UE encapsulates the received UE security capabilities which are present within the DIRECT_COMMUNICATION_REQUEST or DIRECT_REKEYING_REQUEST message to trigger the DIRECT SECURITY MODE COMMAND message.

The commanding UE transmits the DIRECT SECURITY MODE COMMAND message which is not encrypted, but integrity-protects the corresponding message with a new security context. After transmitting the DIRECT_SECURITY_MODE_COMMAND message, the commanding UE starts a timer T4111.

3) Direct Security Mode Control Procedure Accepted by Peer UE

Referring to FIG. 10(a), when receiving the DIRECT_SECURITY_MODE_COMMAND message, the peer UE checks whether a security mode command may be accepted. This is performed by checking the integrity of the message and comparing the received UE security capabilities with a last value which the peer UE transmits to the commanding UE within the DIRECT_COMMUNICATION_REQUEST or DIRECT_REKEYING_REQUEST message and checking that the corresponding is replaced.

In order to check the integrity, the peer UE needs to generate the security context. When the MSB of the K_D ID is included in the DIRECT_SECURITY_MODE_COMMAND message, the peer UE performs one of two operations described below:
When performing the isolated one-to-one ProSe direct communication, the peer UE first checks a signature included in SIGN IE of the DIRECT SECURITY MODE COMMAND and acquires the fresh K_D from the Encrypted Payload IE; or
When the peer UE is the remote UE that receives the DIRECT_SECURITY_MODE_COMMAND from the ProSe UE-to-network relay UE, the peer UE replaces the PRUK ID and the PRUK thereof if the GPI IE is included in the DIRECT_SECURITY_MODE_COMMAND. Eventually, the UE derives the fresh K_D.

When the MSB of the K_D ID is not included in the DIRECT_SECURITY_MODE_COMMAND message, the peer UE uses the existing K_D indicated by the K_D ID included in the DIRECT_COMMUNICATION_REQUEST message or a currently used K_D.

The peer UE derives the K_D-sess based on the K_D-sess ID in the same scheme as the commanding UE. As a result, the peer UE uses the algorithm indicated in the Chosen Algorithms IE.

When the DIRECT_SECURITY_MODE_COMMAND message may be accepted, the peer UE transmits a DIRECT_SECURITY_MODE_COMPLETE message encrypted and integrity-protected with a new security context. The DIRECT_SECURITY_MODE_COMPLETE message contains least significant 16 bits of the K_D ID if the initiating UE includes the MSB of the K_D ID in the DIRECT_SECURITY_MODE_COMMAND message.

From this time, the peer UE protects all signaling messages and user data with the new security context.

4) Completion of Direct Security Mode Control Procedure by Commanding UE

Upon receiving the DIRECT_SECURITY_MODE_COMPLETE message, the commanding UE stops the timer T4111. When the LSB of the K_D ID IE is included in this message, the commanding UE uses the LSB of the K_D ID IE and the MSB of the previously transmitted K_D ID in order to form the K_D ID of the fresh K_D. From this time, the commanding UE protects all signaling messages and user data with the new security context.

5) Direct Security Mode Control Procedure Accepted by Peer UE

When the DIRECT_SECURITY_MODE_COMMAND message may not be accepted, the peer UE transmits a DIRECT_SECURITY_MODE_REJECT message. The DIRECT_SECURITY_MODE_REJECT message includes a PC5 Signaling Protocol Cause Value IE indicating one cause value of the following cause values:

#7: UE security capabilities mismatch;

#8: Unspecified error; or

#9: Authentication synchronization error.

When processing an authentication vector included in the GPI payload transmitted to the remote UE by the ProSe UE-to-network relay UE, if the DIRECT_SECURITY_MODE_COMMAND may not be accepted due to a synchronization error, the peer UE encapsulates random challenge (RAND) and Authentication Token (AUTS) parameters in the DIRECT_SECURITY_MODE_REJECT message.

Upon receiving the DIRECT_SECURITY_MODE_REJECT message, the commanding UE stops the timer T4111. When the PC5 Signaling Protocol Cause Value IE indicates the synchronization error and the message includes the RAND and the AUTS, the ProSe UE-to-network relay transmits a key request message including the RAND and the AUTS to a fresh K_D from the PKMF. Otherwise, the UE terminates the ongoing procedure in which the initiation of the direct security mode control procedure is triggered.

6) Abnormal Case

When the timer T4111 expires, and
when the direct security mode control procedure is triggered by the DIRECT_COMMUNICATION_REQUEST message, the commanding UE discards any derived key with Nonce_1 and transmits the DIRECT_COMMUNICATION_REJECT message with the PC5 Signaling Protocol Cause Value IE set to #10 “non-responsive peer during the direct security mode procedure”; or
when the direct security mode control procedure is triggered by the DIRECT_REKEYING_REQUEST message, the commanding UE continuously uses the previous key until the corresponding key is not valid any longer.

When the DIRECT_SECURITY_MODE_COMMAND message is malformed, the peer UE discards this message.

7) PC5_Signaling Message Related to Direct Security Mode Control Procedure

i) DIRECT_SECURITY_MODE_COMMAND

The message is transmitted by the UE to the peer UE to establish the security of the direct link.

Table 5 shows the DIRECT_SECURITY_MODE_COMMAND message.

TABLE 5

| IEI | Information element | Type/Reference | Presence | Format | Length |
|---|---|---|---|---|---|
| | DIRECT_SECURITY MODE COMMAND | PC5-SP Message Type | M | V | 1 |
| | message identity | TS 24.334 12.5.1.1. | | | |
| | Sequence Number | Sequence Number | M | V | 2 |
| | | TS 24.334 12.5.1.2 | | | |
| | UE Security Capabilities | UE Security Capabilities | M | V | 2 |
| | | TS 24.334 12.5.1.22 | | | |
| | Nonce 2 | Nonce 2 | M | V | 16 |
| | | TS 24.334 12.5.1.31 | | | |
| | Chosen Algorithms | Chosen Algorithms | M | V | 1 |
| | | TS 24.334 12.5.1.23 | | | |
| | LSB of K_D-sess ID | LSB of K_D-sess | M | V | 1 |
| | | TS 24.334 12.5.1.24 | | | |
| 16 | MSB of K_D ID | MSB of K_D ID | O | TV | 3 |
| | | TS 24.334 12.5.1.27 | | | |
| 18 | K_D Freshness | K_D Freshness | O | TV | 17 |
| | | TS 24.334 12.5.1.30 | | | |
| 24 | GPI | GPI | O | TLV | Variable |
| | | TS 24.334 12.5.1.18 | | | |
| 1 | User Info | User Info | O | TLV | 3-253 |
| | | TS 24.334 12.5.1.3 | | | |
| 22 | Signature | Signature | O | TV | 130 |
| | | TS 24.334 12.5.1.33 | | | |
| 23 | Encrypted Payload | Encrypted Payload | O | TLV | Variable |
| | | TS 24.334 12.5.1.34 | | | |

ii) DIRECT_SECURITY_MODE_COMPLETE

The message is transmitted by the peer UE to the commanding UE to confirm the security establishment.

Table 6 shows the DIRECT_SECURITY_MODE_COMPLETE message.

TABLE 6

| IEI | Information Element | Type/Reference | Presence | Format | Length |
|---|---|---|---|---|---|
| | DIRECT_SECURITY MODE COMPLETE | PC5-SP message type | M | V | 1 |
| | message identity | TS 24.334 12.5.1.1. | | | |
| | Sequence Number | Sequence Number | M | V | 2 |
| | | TS 24.334 12.5.1.2 | | | |
| 15 | LSB of K_D ID | LSB of K_D ID | O | TV | 3 |
| | | TS 24.334 12.5.1.26 | | | |

iii) DIRECT_SECURITY_MODE_REJECT

The message is transmitted by the peer UE to the commanding UE to indicate that the security establishment is unsuccessful.

Table 7 shows the DIRECT_SECURITY_MODE_REJECT message.

TABLE 7

| IEI | Information element | Type/Reference | Presence | Format | Length |
|---|---|---|---|---|---|
| | DIRECT_SECURITY MODE REJECT | PC5-SP message type | M | V | 1 |
| | message identity | TS 24.334 12.5.1.1. | | | |
| | Sequence Number | Sequence Number | M | V | 2 |
| | | TS 24.334 12.5.1.2 | | | |
| | PC5 Signalling Protocol Cause Value | PC5 Signalling Protocol | M | V | 1 |
| | | Cause Value | | | |
| | | TS 24.334 12.5.1.7 | | | |
| 10 | RAND | RAND | O | TV | 17 |
| | | TS 24.334 12.5.1.21 | | | |
| 9 | AUTS | AUTS | O | TV | 15 |
| | | TS 24.334 12.5.1.20 | | | |

Discovery Models

Hereinafter, a discovery model defined in D2D (or ProSe) will be described. The discovery model is divided into Model A and Model B. In the UE-to-Network Relay, in the case of Model A, when the relay UE becomes an announcing UE, the remote UE corresponds to a monitoring UE. In the UE-to-Network Relay, in the case of Model B, when the remote UE becomes a discoverer UE, the relay UE corresponds to a discoveree UE.

1) Model A (“I am Here”)

This model defines two roles for a ProSe-enabled UE(s) which participates in a ProSe direct discovery.
Announcing UE: The UE announces specific information which may be used by a nearby UE which is allowed to be discovered.
Monitoring UE: The UE monitors specific information of an interested nearby announcing UE.

In this model, the announcing UE broadcasts a discovery message at a predetermined discovery interval and the monitoring UE that is interested in the message reads and processes the corresponding message.

In Model A mode, the UE may operate as the “announcing UE” only within a carrier frequency signaled by the serving PLMN, but may operate as the “monitoring UE” within resources of the serving PLMN and a local PLMN. When inter-PLMN discovery transmission is supported, the carrier frequency may be operated by a PLMN other than the serving PLMN.

An open and restricted discovery type is supported by Model A.

2) Model B (“Who is There?”/“Are You There?”)

When the proposed discovery type is used, this model defines two roles for a ProSe-enabled UE(s) which participates in a ProSe direct discovery.
Discoverer UE: The UE sends a request containing specific information regarding a UE to be discovered.
Discoveree UE: The UE that receives the request message may respond with information related to a request of a discoverer.

Since the discoverer UE transmits information regarding other UEs that desire to receive a response (e.g., information regarding a ProSe application identifier corresponding to a group, members of the group may respond), “who is there” and “are you there” are equal to each other.

When using Model B discovery, the discoverer UE and the discoveree UE may broadcast within the carrier frequency signaled by the serving PLMN. When inter-PLMN discovery transmission is supported, the carrier frequency may be operated by a PLMN other than the serving PLMN. The discoverer UE and the discoveree UE are allowed to monitor or broadcast within the serving PLMN and the authorized local PLMN.

Only the restricted discovery type is supported by Mode B.

It is regarded that a public safety discovery is supported. The monitoring UE/discoverer UE needs to be authorized to perform the discovery of an appropriate service (via pre-provisioned parameters).

PC5 Discovery Message for UE-to-Network Relay

Hereinafter, a PC5_discovery message defined for the discovery of the PC5_Discovery message for UE-to-network relay in D2D (or ProSe).

A PC5_DISCOVERY message for UE-to-Network Relay discovery announcement to be described below is used in Mode A. A PC5_DISCOVERY message for UE-to-Network Relay discovery solicitation and a PC5_DISCOVERY message for UE-to-Network Relay Discovery Response are used in Model B.

A PC5_DISCOVERY message for the UE-to-Network Relay Discovery Announcement and a PC5_DISCOVERY message for the UE-to-Network Relay Discovery Response transmitted by the Relay UE include a Status Indicator IE. The Status Indicator IE includes a Resource Status Indicator (RSI) parameter. The RSI parameter indicates whether the relay UE may support an additional remote UE.

Table 8 shows the PC5_DISCOVERY message for the UE-to-Network Relay Discovery Announcement.

TABLE 8

| | | | Length |
|---|---|---|---|
| Information element | Type/Reference | Presence | (bit) |
| Message Type | Message Type | M | 8 |
| | TS 24.334 12.2.2.10 | | |
| Relay Service Code | Binary | M | 24 |
| | TS 24.334 12.2.2.51 | | |
| Information of announcing | Binary | M | 48 |
| UE (Announcer Info) | TS 24.334 12.2.2.50 | | |
| ProSe Relay UE ID | Binary | M | 24 |
| | TS 24.334 12.2.2.49 | | |
| Status Indicator | Binary | M | 8 |
| | TS 24.334 12.2.2.67 | | |
| Spare | Binary | M | 80 |
| | TS 24.334 12.2.2.56 | | |
| Message Integrity Check | Binary | M | 32 |
| (MIC) | TS 24.334 12.2.2.11 | | |
| Date and time (UTC)-based | Binary | M | 8 |
| Counter LSB | TS 24.334 12.2.2.22 | | |

The discovery type is set to the “Restricted discovery”, the content type is set to “UE-to-Network Relay Discovery Announcement or UE-to-Network Relay Discovery Response”, and a discovery model is set to “model A”.

Table 9 shows the PC5_DISCOVERY message for the UE-to-Network Relay Discovery Solicitation.

TABLE 9

| | | | Length |
|---|---|---|---|
| Information element | Type/Reference | Presence | (bit) |
| Message Type | Message Type | M | 8 |
| | TS 24.334 12.2.2.10 | | |
| Relay Service Code | Binary | M | 24 |
| | TS 24.334 12.2.2.51 | | |
| Information of | Binary | M | 48 |
| discoverying UE | TS 24.334 12.2.2.50 | | |
| (Discoverer Info) | | | |
| UE-to-Network Relay | Binary | M | 8 |
| Discovery Solicitation | TS 24.334 12.2.2.66 | | |
| (URDS) Composition | | | |
| ProSe Relay UE ID | Binary | C | 24 |
| | TS 24.334 12.2.2.49 | (NOTE 2) | |
| Spare | Binary | M | 80 or 104 |
| | TS 24.334 12.2.2.56 | | (NOTE 3) |
| MIC | Binary | M | 32 |
| | TS 24.334 12.2.2.11 | | |
| UTC-based Counter LSB | Binary | M | 8 |
| | TS 24.334 12.2.2.22 | | |

The discovery type is set to the “Restricted discovery”, the content type is set to “UE-to-Network Relay Discovery Announcement or UE-to-Network Relay Discovery Solicitation”, and the discovery model is set to “model B”.
The presence of the ProSe Relay UE ID is indicated by the ProSe Relay UE ID. When the ProSe Relay UE ID is present, the length of the spare is 80 bits. When the ProSe Relay UE ID is not included, the length of the spare is 104 bits.

Table 10 shows the PC5_DISCOVERY message for the UE-to-Network Relay Discovery Response.

TABLE 10

| | | | Length |
|---|---|---|---|
| Information element | Type/Reference | Presence | (bit) |
| Message Type | Message Type | M | 8 |
| | 12.2.2.10 | | |
| Relay Service Code | Binary | M | 24 |
| | 12.2.2.51 | | |
| Information of discovered UE | Binary | M | 48 |
| (Discoveree Info) | 12.2.2.50 | | |
| ProSe Relay UE ID | Binary | M | 24 |
| | 12.2.2.49 | | |
| Status Indicator | Binary | M | 8 |
| | 12.2.2.67 | | |
| Spare | Binary | M | 80 |
| | 12.2.2.56 | | |
| Message integrity check | Binary | M | 32 |
| (MIC) | 12.2.2.11 | | |
| UTC-based Counter LSB | Binary | M | 8 |
| | 12.2.2.22 | | |

The discovery type is set to the “Restricted discovery”, the counter type is set to “UE-to-Network Relay Discovery Announcement or UE-to-Network Relay Discovery Response”, and the discovery model is set to “model B”.

The status indicator parameter is used for indicating the status of the ProSe UE-to-network relay. The parameter is coded as shown in Table 11 below.

The RSI is used for indicating whether the UE has a resource available for providing a connectivity service for an additional ProSe-enabled public safety UE.

Table 11 shows the status indicator parameter.

TABLE 11
RSI (octet 1)

| | |
|---|---|
| Bit | |
| 8 | |
| 0 | The UE does not have the resource available for providing |
| | the connectivity service for the ProSe-enabled public safety |
| | UE(s). |
| 1 | The UE has the resource available for providing the |
| | connectivity service for the ProSe-enabled public safety |
| | UE(s). |

Bits 1 to 7 of octet 1 are spare and coded to 0.

Direct Communication Via ProSe UE-to-Network Relay

Hereinafter, an operation (3-layer relay) related to direct communication via the ProSe UE-to-Network Relay in ProSe will be described.

A UE capable of performing the ProSe UE-to-Network Relay is enabled may be attached to the network (if it is not already connected), connect a PDN connection that enables required relay traffic, or need to connect an additional PDN connection(s) in order to provide the relay traffic toward the remote UE(s). The PDN connection(s) supporting the UE-to-Network Relay is used only for the relay traffic of the Remote ProSe UE(s).

FIG. 11 illustrates a UE trigger Service Request procedure in a wireless communication system to which the present invention can be applied

1-2. The UE initiates a UE-triggered Service Request procedure by transmitting a Service Request message to the MME.

The Service Request message is delivered being included in an RRC connection setup complete message through the RRC connection and delivered being included in an initial UE message through the S1 signaling connection.

3. For authentication of the UE, the MME requests and receives information for the authentication from the HSS; and performs mutual authentication with the UE.

4. The MME transmits an Initial Context Setup Request message to the eNB so that the eNB can configure an S1 bearer with the S-GW and configure a DRB with the UE.

5. The eNB transmits an RRC Connection Reconfiguration message to the UE to create the DRB.

When this procedure is done, the creation of DRB is completed between the eNB and the UE, and all of uplink EPS bearers ranging from the UE to the P-GW are configured. The UE can transmit uplink traffic data to the P-GW.

6. The eNB transmits an Initial Context Setup Complete message including ‘S1 eNB TEID’ to the MME in response to the Initial Context Setup Request message.

7. The MME delivers the ‘S1 eNB TEID’ received from the eNB to the S-GW through a Modify Bearer Request message.

When this procedure is done, the creation of S1 bearer is completed between the eNB and the S-GW, and then all of the downlink EPS bearers ranging from the P-GW and the UE are configured. The UE can then receive downlink traffic data from the P-GW.

8. In case that a cell (E-UTRAN cell global Identifier; ECGI) where a UE is located or tracking area (TAI) is changed, the S-GW informs that by transmitting a modify bearer request message to the P-GW.

9. If needed, the P-GW can perform an IP connectivity access network (IP-CAN) session modification procedure with the PCRF.

10. Receiving a Modify Bearer Request message from the S-GW, the P-GW transmits a Modify Bearer Response message to the S-GW in response to the message.

11. The S-GW transmits a Modify Bearer Response message to the MME in response to the Modify Bearer Request message.

A network-triggered Service Request procedure is usually performed when the network attempts to transmit downlink data to the UE staying in the ECM-IDLE state.

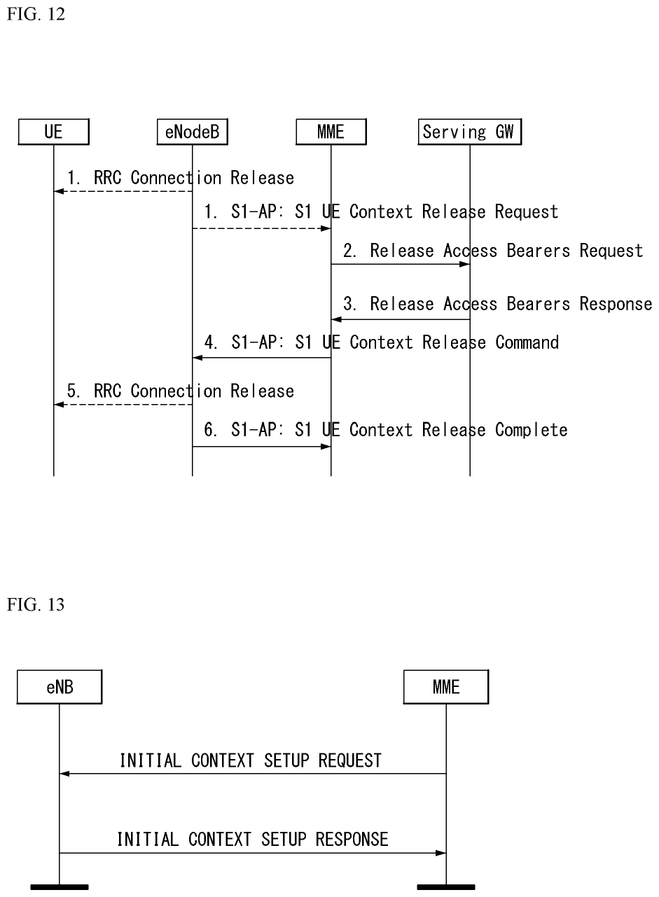

FIG. 12 is a diagram exemplifying an S1 release procedure in a wireless communication system to which the present invention can be applied.

In FIG. 12, both of the eNB-initiation and the MME-initiation are exemplified.

1a. In a specific case, an eNB may release signaling connection of UE before requesting release of S1 context to MME or with the request (e.g., the case that an eNB initiates a RRC connection release for CS fallback by redirection).

1b. When an eNB detects that signaling connection of UE or all radio bearers for the corresponding UE are required to be released, the eNB transmits an S1 UE context release request (cause) message to MME.

Here, the cause indicates the reason of release (e.g., operation and management (O&M) Intervention, unspecified failure, user inactivity, repeated integrity check failure or release due to UE generated signaling connection release).

Here, step 1 is performed only in case that the eNB-initiated S1 release procedure is considered. When the MME-initiated S1 release procedure is considered, step 1 is not performed, and the procedure is started from step 2.

2. An MME transmits a release access bearers request (abnormal release of radio link indication) message to an S-GW for requesting release of all S1-U bearers for UE. This message is triggered by an S1 release request message from the eNB or other MME event. The abnormal release of radio link indication is included in case that the S1 release procedure is due to an abnormal release of radio link.

3. The S-GW releases all eNB-related information (address and tunnel end point identifier (TEID)), and responds to the MME by a release access bearers response message. The other elements of S-GW context of UE are not influenced.

The S-GW maintains the S1-U configuration that the S-GW allocated for bearer of UE.

When downlink packets are arrived for UE, the S-GW starts to buffer downlink packets which are received for UE, and initiates a network-triggered service request procedure.

Based on the policy of operator, the S-GW may be used to determine the subsequent determinations to trigger discontinuation of PDN charge using the received abnormal release of radio link indication.

4. The MME releases S1 by transmitting the S1 UE context release command (cause) message to the eNB.

5. If the RRC connection is still not released, the eNB transmits a RRC connection release message to the UE in AM mode. If the RRC connection release message is received and responded by UE, the eNB deletes context of UE.

6. The eNB checks S1 release by replying an S1 UE context release complete) (ECGI, TAI) message to the MME. The signaling connection between the MME and eNB for the corresponding UE is also released. This step is, for example, performed immediately after step 4 in order not to be retarded in a situation that the UE does not respond to the RRC connection release.

The MME deletes eNB-related information (“eNB address used for S1-MME”, “MME UE S1 AP ID” and “eNB UE S1AP ID”) from the MME context. However, the MME maintains the remaining information of the MME context of UE including the S1-U configuration information (address and TEID) of S-GW. All non-guaranteed beat ratio (non-GBR) EPS bearers which are established for the corresponding UE are preserved in the MME and the S-GW.

If the cause of S1 release is due to the User Inactivity and Inter-RAT redirection, the MME preserves the GBR bearers. If the cause of S1 release is due to CS fallback trigger, a procedure for bearer handling may be performed. Otherwise (e.g., in case that radio connection with UE is disconnected, S1 signaling connection is disconnected, eNB failure, etc.), the MME triggers an MME initiated dedicated bearer deactivation procedure for GBR bearers of UE after the S1 release procedure is completed.

When local IP access (LIPA) is activated for PDN connection, a home eNB (HeNB) notifies to release a direct user plane path to the HeNB to a collocated local gateway (L-GW) through internal signaling. When downlink packets for UE are arrived after the direct user plane path is released, the L-GW delivers the first packet to the S-GW through S5 tunnel such that the S-GW initiates a network-triggered service request procedure.

FIG. 13 is a diagram illustrating an initial context setup procedure to which the present invention can be applied.

The initial context setup procedure is for setting up all necessary UE context information. The UE context information may include an E-RAB context, a security key, a handover restriction list, UE radio capability and/or UE security capability, and the like. That is, the context information (or UE context information) may include comprehensive information of the UE.

In this case, since the UE radio capability information may be transmitted when the MME has such information, the UE radio capability information may not be transmitted when the initial MME does not know the UE.

For the initial context setup, the MME may transmit an initial context setup request message to the eNB.

The eNB receiving the initial context setup request message transmits an initial context setup response message as a response to the initial context setup request message to the MME to perform the initial context setup procedure.

In this case, the eNB may report to the MME the successful establishment of the security procedure with the UE and results of all requested E-RABs in the initial context setup response message in the following manner.
Include a successfully established list of E-RABs in an E-RAB settings list IE.
Include a list of E-RABs which fail to set in a failed E-RAB settings list IE.

When the eNB reports the establishment failure of the E-RAB, a cause value should be correct so that the MME can fully understand the cause of the establishment failure, such as “radio resource not available” or “failure in radio interface procedure”.

In addition, the eNB may transmit the initial context setup response message to the MME when some or all of DRBs are successfully established.

The eNB shall report to the MME the successful establishment of the security procedure with the UE and the results of all requested E-RABs in the initial context setup response message in the following manner.

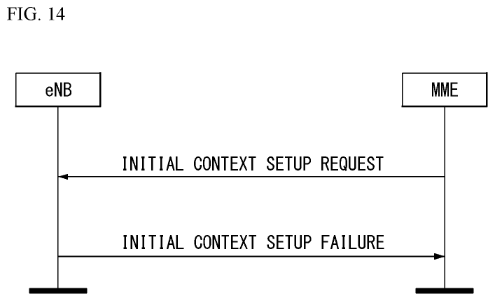

FIG. 14 is a diagram illustrating the initial context setup procedure to which the present invention can be applied.

FIG. 14 is a diagram illustrating a case where the initial context setup procedure described with reference to FIG. 13 fails.

Specifically, as illustrated in FIG. 13, the MME may transmit the initial context setup request message to the eNB for the initial context setup.

However, when the eNB cannot establish the S1 UE context or the GBR bearer, the eNB regards the initial context setup procedure as failure and transmits an initial context setup failure message to the MME.

In this case, the eNB may assume that the initial context setup procedure has failed in the following abnormal condition.

Abnormal Conditions

If the eNB receives from the MME the initial context setup request message that includes a QCI IE (see 3GPP 23.203) indicating a GBR bearer and an E-RAB level QoS parameter IE not including a GBR QoS information IE, the eNB considers that the establishment of the corresponding E-RAB has failed.

Alternatively, if the eNB receives from the MME the initial context setup request message that includes several E-RAB ID IEs set to have the same value, the eNB considers that the establishment of the corresponding E-RABs has failed.

When the algorithms supported for encryption defined in an encryption algorithm IE of a UE security features IE do not match the allowed algorithms defined in a configured list of encryption allowed for essential support of EEA0 in all UEs (TS 33.401 [15]), the eNB should reject the procedure using the INITIAL CONTEXT SETUP FAILURE message in the algorithm (see 3GPP TS 33.401).

When the integrity algorithms defined in an integrity protection algorithm IE of the UE security features IE do not match the allowed algorithms defined in the configured list of delegated support for EIA0 algorithm of all UEs (see 3GPP TS 33.401), the eNB should reject a procedure using the INITIAL CONTEXT SETUP FAILURE message with the exception of one of the integrity protection algorithms allowed in the eNB (see 3GPP TS 33.401).

If a CSG membership status IE is not included in the initial context setup request message and a cell accessed by the UE is a hybrid cell, the eNB should reject the procedure using the INITIAL CONTEXT SETUP FAILURE message.

When the eNB receives the initial context setup request message including both a correlation ID and an SIPTO correlation ID IE for the same E-RAB, the eNB should regard the configuration of the corresponding E-RAB as a failure.

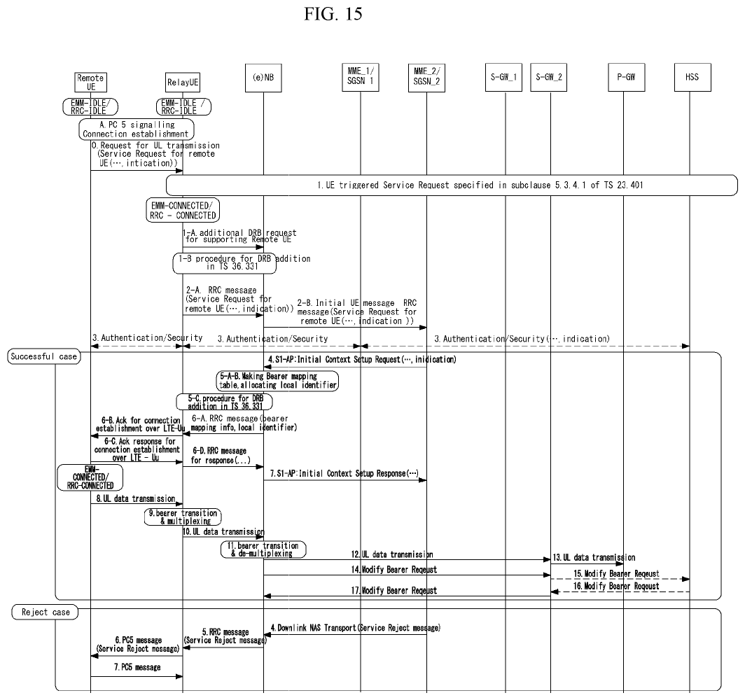

FIG. 15 is a diagram illustrating a data transmission method through a configuration of a radio data bearer for a remote UE according to an embodiment of the present invention.

A. The remote UE performs a procedure (see 3Gpp TS 24.334 v15.1.0) for establishing a PC5 signaling connection. The PC5 signaling connection establishment procedure may be performed at a time when the remote UE needs UL transmission over LTE-Uu (time triggered by the UE) or may be performed in advance for other reasons.

In this case, the remote UE is EMM-IDLE mode/RRC-IDLE mode.

0. The remote UE transmits a request message for UL transmission to the relay UE through a PC5 link established between the remote UE and the relay UE.

The remote UE notifies the relay UE through the request message that signaling (RRC message or NAS message) or data to be transmitted on the uplink are generated.

In this case, the request message, which is a PC5 message transmitted through the PC5 link between the remote UE and the relay UE, may be a PC5-S message for transmitting signaling to the relay UE, a PC5-U message for transmitting and receiving data between the relay UE and the remote UE, or a new type of PC5 message.

When the PC5 message is the PC5-S message or the PC5-U message, the PC5 message may include an indicator indicating that the PC5 message is not transmitted to the relay UE but is a message transmitted to a network by being relayed.

In this case, a second indicator may be referred to as an associated service request indication.

The PC5 message may include an RRC message, and the RRC message may encapsulate a NAS message. The RRC message may include S-TMSI or GUMMEI to deliver NAS messages to the associated MME (MME_2) by the prior art (see 3GPP TS 24.301, v15.1.1).

In step 0, the NAS message included in the PC5 message is a service request message (or extended service request message) for a service request described with reference to FIG. 11 or a new type of NAS message (for example, associated service request message) including the same IE included in a service request message (or extended service request message) shown in FIG. 11.

The NAS message may indicate that the remote UE performs the transmission over LTE-Uu through the relay UE.

That is, when a message (for example, a service request message or a extended service request message) used in the existing service request procedure is used as the NAS message, the NAS message may include information like an indicator indicating that the NAS message is a message for the remote UE.

In this case, the indicator may be referred to as an associated service request indication.

In addition, the NAS message may be an attach message for initial access or a TAU message of a tracking area update (TAU) procedure for periodically reporting location information of a UE to a network (MME).

i. If the NAS message is the attach message or the TAU message, the attach procedure or the TAU procedure is performed, and then a separate service request procedure is performed.

ii. When the attached procedure or the TAU procedure is performed, the associated service request procedure may be performed.
In this case, the attach message or the TAU message may include an indicator indicating that the NAS message is the message for the remote UE, and the TAU message may further include an active flag.

D. In order for the remote UE to perform the operation in the service request procedure of FIG. 11 including the S-TMSI or the GUMMEI in the RRC message, the remote UE should receive tracking area information of the current cell from the relay UE.

To this end, the relay UE may transmit the tracking area information of the current cell to the remote UE at all times (for example, whenever the SIB information is changed) or when an event occurs.

For example, prior to step 0, when the remote UE transmits the indicator indicating that the uplink transmission is required to the relay UE without an RRC message, and then receives the tracking area information from the relay UE in response, the RRC message is configured based on the tracking area received by the remote UE and the relay UE may transmit the tracking area information to the remote UE when there is the request of the remote UE, like transmitting the configured RRC message by including the RRC message in a separate PC5 message.

1. If the relay UE accepts the request for delivering the RRC message of the remote UE received in step 0), the relay UE performs a UE triggered service request procedure for establishing its own LTE-Uu connection. The relay UE, which has successfully performed the UE triggered service request procedure, transitions its own state to EMM-CONNECTED/RRC-CONNECTED mode.

Prior to step 1), when the relay UE is in the EMM-CONNECTED/RRC-CONNECTED mode, step 1) may not be performed.

When the relay UE does not accept the request of the remote UE, the relay UE transmits an accept reject message to the relay UE through the PC5 interface between the remote UE and the relay UE.

In this case, the accept reject message includes a reject cause of the relay UE.

If the relay UE determines that an additional DRB needs to be established to support the remote UE (for example, when the DRB of the relay UE is not sufficient to transmit user traffic of the remote UE), step 1-A) for establishing an additional DRB is performed, and the eNB may perform step 1-B).

In other words, when the relay UE determines that the DRB pre-established between the relay UE and the eNB cannot support the uplink and downlink transmission of the remote UE, the relay UE establishes an additional DRB.

However, when the relay UE determines that the DRB pre-established between the relay UE and the eNB can support the uplink and downlink transmission of the remote UE, the relay UE does not establish an additional DRB.

If it is determined that the establishment of the additional DRB is not required, the relay UE performs the following step (step 2-A) without performing step 1-A) and step 1-B).

A. When the establishment of the additional DRB is required, the relay UE may transmit the RRC message (for example, DRB addition request message) to the base station to request the base station to establish the additional DRB for supporting the remote UE in EMM-CONNECTED/RRC-CONNECTED mode.

The RRC message may include a cause or indicator indicating a cause for adding a DRB for the DRB addition request.

For the procedure for adding the DRB, the remote UE may include a bearer list of the remote UE and QoS information (QCI value, guaranteed bit rate (GBR) and the maximum bit rate (MBR) values for uplink and downlink) of each bearer in the PC5 message transmitted in step 0). The relay UE determines whether the DRB needs to be added based on the bearer list and/or the QoS information.

i. The bearer list and the QoS information may be similar to the bearer list and the QoS information included in the initial context setup information.

B. When the eNB receiving the RRC message from the relay UE accepts the DRB addition request of the relay UE, the eNB may perform an operation with the relay UE to establish the additional DRB (see 3GPP TS 36.331, v15.0.1) (the operation of establishing the additional DRB may also be performed by the eNB even in step 5) by step 4).

i. The eNB includes drb-identity to be added in the drb-ToAddModList and transmits the drb-identity to the relay UE by including the drb-identity in radioResourceConfigDedicated (see 3GPP TS 36.331, v15.0.1). In this case, the drb-ToAddModList includes information indicating that the DRB to be added is a DRB for supporting the remote UE.

ii. Upon receiving this, the UE performs an operation (see 3GPP TS 36.331, v15.0.1) of establishing the additional DRB.

iii. In the above, the eNB may check the authorization for the relay UE and the capability of the relay UE (for example, UE-AMBR) and determine whether to accept the request of the relay UE in step A).

C. When the eNB cannot establish one additional DRB for the request of the relay UE in step A), the eNB may transmit the accept reject message to the relay UE, and the accept reject message may be referred to as a DRB addition reject message.

In this case, the accept reject message may include a reject cause indicating a reason for not establishing the additional DRB, and the reason for not establishing the additional DRB may be as follows.
‘relay UE not authorized’
‘UE-AMBR not allowed’
‘radio resource not enough (congestion)’
‘Network not supported’

If the reject cause is ‘radio resource not enough (congestion)’, the accept reject message may further include a back-off timer (T3xx) value.

i. When the relay UE receives the accept reject message and the reject cause, the relay UE may deliver the reject cause to the remote UE by including the reject cause in the PC5 message.
When among the reasons that the additional DRB cannot be established, the DRB cannot be permanently added (for example, ‘relay UE not authorized’, ‘UE-AMBR not allowed’, or ‘Network not supported’), the PC5 message which the relay UE transmits to the remote UE may be a DIRECT_COMMUNICATION_RELEASE message.

The release cause of the DIRECT_COMMUNICATION_RELEASE message may be the same as the cause of the rejection or may be ‘Direct communication with the peer UE is no longer allowed’, indicating that direct communication with the peer UE is not allowed.
If among the reasons that the additional DRB cannot be established, the DRB cannot be added temporarily (for example, radio resource not enough (congestion) and the like), the accept reject message may include a back-off timer (T3xx) value.

The relay UE may start the back-off timer and request the addition of the DRB again if the back-off timer expires. If the remote UE receives the release cause from the relay UE, the remote UE transmits the received release cause to an upper layer (for example, a NAS layer). In this case, the back-off timer value can be delivered with the cause of the release.

The upper layer receiving the release cause and/or the back-off timer value stops the NAS procedure (request for UL transmission) triggered in step 0) (for example, when the procedure started in step 0) is a service request procedure, T3417 or T3417ext stops). The upper layer may start the received back-off timer, may not start the NAS procedure until the back-off timer expires, and start the NAS procedure again if the back-off timer expires.

D. The operations A) and B) may be performed at all times when the relay UE determines that the additional DRB for the remote UE is needed in the EMM-CONNECTED/RRC-CONNECTED mode.

2. The relay UE transmits the RRC message including the NAS message received in step 0) to the eNB. The eNB receiving the RRC message delivers the NAS message to the MME corresponding to the S-TMSI or the GUMMEI included in the RRC message.

3. The MME, which receives the NAS message, performs the Authentication/Security procedure. In this case, the MME may include the indicator received in step 2-B). The HSS which receives the indicator responds to the MME by checking subscription information whether the corresponding remote UE is authorized to perform transmission and/or reception associated with the relay UE. In this case, an identifier (e.g. GUTI, IMSI or S-TMSI) of the associated relay UE may be delivered together.

4. The MME_2 receiving the response to the authorization from the HSS or checking the authorization information of the remote UE in the UE context (for example, the subscription information) received from the HSS transmits an S1AP message for establishing the E-UTRAN radio access bearer (E-RAB) of the remote UE to the eNB.

That is, the MME_2 establishes the S1 bearer of the remote UE and, if necessary, establishes a new DRB of the relay UE to support the bearer of the remote UE, or transmits the S1AP message to the eNB to map the previously established DRB of the relay UE to the DRB for the remote UE.

The S1AP message is a message for requesting the establishment of the E-RAB for the remote UE and may be referred to as a remote UE context setup message or an initial context setup message.

The S1AP message may include the UE context and the bearer context information of the UE included in the initial context setup message described with reference to FIG. 11, and may further include the indicator and/or the identifier of the associated relay UE as described in step 1) above.

In this case, the indicator may indicate that the S1AP message (or initial context setup request message) is a message for the remote UE or may indicate that the E-RAB established through the S1AP message is a bearer for the remote UE, and may be referred to as an associated service request indication as described above.

The MME_2 may acquire the identifier of the associated relay UE by the following method.

A. The identifier is acquired from the HSS in step 3), or included in the UE context (i.e. subscription information) of the remote UE acquired from the HSS,

B. The identifier can be received from the remote UE or the relay UE.

i. When the identifier is received from the remote UE, if the identifier of the associated relay UE (GUTI, IMSI, S-TMSI, or C-RNTI) may be included in the RRC message in step 0) and is delivered to the eNB through step 2-A) by being included in the RRC message of step 0), the eNB may deliver the identifier to the MME_2 through step 2-B).

C. When the identifier is received from the relay UE, if the relay UE transmits its own identifier (GUTI, IMSI, S-TMSI, or C-RNTI) to the eNB by including the identifier in the RRC message of the remote UE in step 2-A), the identifier may be delivered to the MME through step 2-B.

5. The eNB which receives the indicator and/or the identifier of the associated relay UE along with the initial context setup message performs the following operation.

The operation of the eNB may be differentiated as follows according to whether the eNB accepts the E-RAB establishment request through the initial context setup message and whether the relay UE establishes the additional DRB to support the remote UE.

In the following, step A) is a common operation when the eNB accepts the E-RAB establishment request, step B) indicates the case where the establishment of the additional DRB is not necessary when the eNB accepts the E-RAB establishment request, and step C) indicates the case where the establishment of the additional is necessary when the eNB accepts the E-RAB establishment request. step D) indicates when the eNB does not accept the E-RAB establishment request.

A. When the eNB accepts the E-RAB establishment request, the eNB may generate a mapping table between the DRB for the remote UE and the DRB established in the relay UE associated with the remote UE, and may generate (or, allocate) a local identifier for identifying the remote UE. In this case, the generated local identifier may be C-RNTI or a new type of identifier.

B. The eNB determines whether the relay UE can support the DRB for the remote UE by at least one DRB established in the relay UE based on the bearer information of the remote UE in the initial context setup message received in step 4).

That is, it is determined whether the DRB established between the remote UE and the eNB is sufficient to transmit the uplink and downlink data of the remote UE.

If the uplink and downlink data of the remote UE can be sufficiently transmitted by the established DRB, subsequent steps including step 6 are performed without performing step C) or D) below.

C. However, when the eNB determines that the additional DRB need to be established because the eNB cannot sufficiently support the uplink and downlink transmission of the remote UE by the previously established DRB, the eNB performs an operation of establishing the additional DRB (see 3GPP TS 36.331, v15.0.1).

When performing an operation of establishing the additional DRB, the eNB establishes the additional DRB for supporting the remote UE and performs step 6).

i. The eNB includes the drb-identity to be added in the drb-ToAddModList and transmits the drb-identity to the relay UE by including the drb-identity in the radioResourceConfigDedicated (see 3GPP TS 36.331, v15.0.1).

In this case, the drb-ToAddModList includes the information indicating that the established DRB to be added is the DRB for supporting the remote UE.

ii. The UE receiving the information performs an operation (see 3GPP TS 36.331, v15.0.1) of adding the DRB.

iii. The eNB may check the authorization for the relay UE and the capability of the relay UE (for example, UE-AMBR) and determine whether to accept the DRB addition.

D. When the eNB does not accept the E-RAB establishment request, the eNB transmits the INITIAL CONTEXT SETUP FAILURE message described with reference to FIG. 14 to the MME_2 and does not perform the subsequent process (step 5).

The MME_2 receiving the INITIAL CONTEXT SETUP FAILURE message transmits the accept reject message (for example, service reject message) for the NAS message (for example, service request message) of the remote UE received in step 2-A) to the remote UE through the relay UE.

The lower layer (for example, RRC layer) of the remote UE receiving the accept reject message delivers the received message to the upper layer (for example, NAS layer).

The upper layer receiving the accept reject message from the lower layer stops the NAS procedure (request for UL transmission) triggered in step 0) (e.g. example, when the procedure started in step 0) is the service request procedure, T3417 or T3417ext stops).

i. In step E), if the eNB determines that the remote UE cannot be supported by at least one previously established DRB of the relay UE based on the bearer information of the remote UE and does not allow the establishment of the additional DRB, the eNB may perform the following operation.
When the eNB cannot add the DRB to the initial context setup message, the eNB may transmit the reject cause described above to the MME_2 by including the reject cause in the INITIAL CONTEXT SETUP FAILURE message.

The reject cause that cannot establish the additional DRB may be as follows.
‘relay UE not authorized’:
‘UE-AMBR not allowed’:
‘radio resource not enough (congestion)’:
‘Network not supported’:

If the reject cause is ‘radio resource not enough (congestion)’, the accept reject message may further include the back-off timer (T3xx) value.

When the MME_2 receives the accept reject message and the reject cause from the eNB, the reject cause may be transmitted to the remote UE by being included in the response NAS message (for example, NAS reject message) of the NAS procedure (request for uplink transmission) triggered in step 0). The remote UE may perform the following operation according to the received reject cause.
When among the reasons that the additional DRB cannot be established, the DRB cannot be permanently added (for example, ‘relay UE not authorized’, ‘UE-AMBR not allowed’, ‘Network not supported’ or the like), the remote UE may release a direct link with the relay UE.

To this end, the remote UE transmits a DIRECT_COMMUNICATION_RELEASE message. The release cause of the DIRECT_COMMUNICATION_RELEASE message may be the same as the cause of the rejection or may be ‘#2 Direct communication with the peer UE is no longer allowed’ indicating that direct communication with the peer UE is not allowed.
If among the reasons that the additional DRB cannot be established, the DRB cannot be added temporarily (for example, radio resource not enough (congestion) and the like), the back-off timer (T3xx) value may be included in the NAS message. Upon receiving this, the remote UE may start the back-off timer and again perform a NAS procedure (request for UL transmission) when the back-off timer expires.

6. Thereafter, the eNB performs the following operation without establishing a separate DRB for the remote UE.

A. The eNB transmits the RRC message to the relay UE, including the mapping information of the DRB mapped in step 4) and the local identifier of the allocated remote UE.

B. The relay UE receiving the RRC message transmits the PC5 message informing the successful completion of the associated service request procedure (or establishment of the LTE-Uu connection for uplink transmission) to the remote UE. The PC5 message may include an indicator indicating the successful completion of the associated service request procedure (or successful establishment of the LTE-Uu connection for uplink transmission).

C. The remote UE receiving the PC5 message or the indication transmits a response message to the relay UE.

i. Additionally, the remote UE notifies the upper layer (i.e. NAS layer) of the indicator. The NAS layer of the remote UE receiving the indicator recognizes that the NAS procedure triggered in step 0) is successfully terminated, and transitions to the EMM-CONNECTED/RRC-CONNECTED mode. Thereafter, the operation for the uplink transmission is performed.

D. The relay UE receiving the response message from the remote UE transmits an RRC response message including an ID (i.e. local identifier) of the remote UE to the eNB.

In this case, the local identifier may be included in the RRC response message when the response message is received from the remote UE.

7. The eNB receiving the RRC response message of D) in step 6) transmits the S1AP response message (for example, initial context setup response message) to the MME_2.

A. The eNB checks the ID (i.e. local identifier) of the remote UE included in the RRC response message, checks the MME ID corresponding to the remote UE, and transmits the S1AP message to the corresponding MME. The operation may check the ID (i.e. local identifier) of the remote UE or the ID (e.g. C-RNTI) of the relay UE in the RRC message and may deliver the S1AP response message to the serving MME of the UE.

8. The remote UE transitions to EMM-CONNECTED/RRC-CONNECTED mode and then performs the UL transmission. In this case, the remote UE transmits the bearer information of the remote UE to the relay UE by including the bearer information of the remote UE in uplink data.

For example, an adaptation layer may include a bearer identity.

9. The relay UE receiving the uplink data of the remote UE maps the DRB of the remote UE to its own mapped DRB through the configured bearer mapping, and multiplexes data corresponding to the mapped DRB.

For example, the relay UE maps the DRB established in the relay UE to the DRB for the remote UE based on the mapping information received from the eNB, and multiplexes data (e.g. data of the remote UE different from data of the relay UE, and the like) transmitted through the mapped DRB).

10. The relay UE transmits the multiplexed data.

11. The eNB receiving the multiplexed data, the eNB demultiplexes the received data, and checks the configured bearer mapping table to transition the demultiplexed data into the bearer of the remote UE.

12. Thereafter, the eNB transmits data to the S-GW of the remote UE.

13. The S-GW transmits the transmitted data to the P-GW.

14 to 16. As described with reference to FIG. 11, the eNB and the S-GW each perform modify bearer request procedures of the remote UE with the S-GW and the P-GW of the remote UE.

The method for delivering an indicator included in a NAS message to MME_2 through step 0 to step 2-2 is described above, but when the service request message described with reference to FIG. 11 is used, the indicator is not included in the NAS message due to the size limitation of the NAS message but can be delivered by being included in each interface message.

That is, the indicator may be delivered by being included in the PC5 message in step 0, delivered by being included in the RRC message in step 2-1, and delivered by being included in the S1-AP message in step 2-2.

The case where the NAS procedure of the remote UE succeeds is described above. The operation of the reject case is as follows.

4 to 6. When the MME rejects the NAS message, the NAS message is delivered to the remote UE.

7. The remote UE receiving the NAS message operates in accordance with the existing NAS rejection cause. In addition, the remote UE performs an operation of informing the relay UE of the failure of the NAS procedure or releasing the PC5 signaling connection with the relay UE.

In this case, the remote UE may deliver an indicator informing this or a release cause (for example, network reject or the like) to the relay UE.

In step 2-A), when the relay UE transmits a signaling message of the remote UE to the eNB, the relay UE starts timer 3xx to determine whether transmission of the signaling message of the remote UE succeeds.

The relay UE may retransmit the corresponding signaling message when there is no response from the eNB until the timer 3xx expires. When the relay UE receives a response from the eNB before the timer 3xx expires, the transmission is considered to succeed and the procedure stops.

In this case, the response may be an RRC message of step 6-A) of a successful case or an RRC message of step 5) of a reject case.

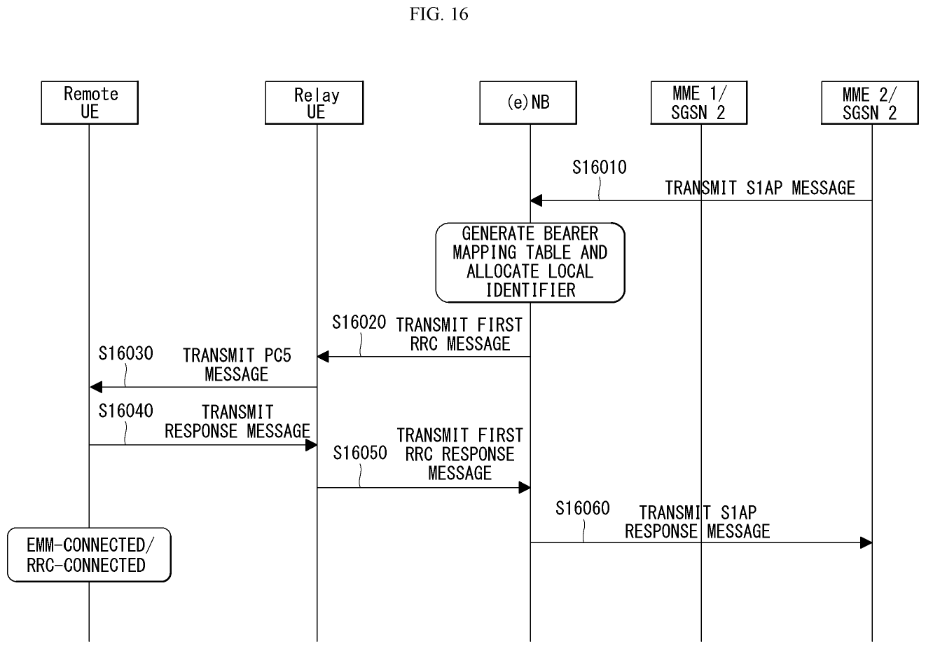

FIG. 16 is a diagram illustrating a data transmission method through a configuration of a radio data bearer for a remote UE according to an embodiment of the present invention.

FIG. 16 is a diagram illustrating in detail a method for allowing an eNB to configure a relay UE and a DRB in a method of transmitting uplink data of a remote UE through the radio bearer configuration described with reference to FIG. 15.

In detail, the MME_2 transmits an S1AP message for establishing the E-UTRAN radio access bearer (E-RAB) of the remote UE to the eNB (S16010).

That is, the MME_2 establishes the S1 bearer of the remote UE and, if necessary, establishes a new DRB of the relay UE to support the bearer of the remote UE, or transmits the S1AP message to the eNB to map the previously established DRB of the relay UE to the DRB for the remote UE.

The S1AP message is a message for requesting the establishment of the E-RAB for the remote UE or the configuration of the UE context of the remote UE, and may be referred to as the remote UE context setup message or the initial context setup message.

The S1AP message may include the UE context and the bearer context information of the UE included in the initial context setup message described with reference to FIG. 11, and may further include the indicator and/or the identifier of the associated relay UE as described with reference to FIG. 15.

The indicator included in the S1AP may indicate that the remote UE performs communication with the network through the relay UE.

In other words, the indicator indicates that the S1AP message (or initial context setup request message) is a message for the remote UE or that the E-RAB to be established through the S1AP message is a bearer for the remote UE.

In this case, the MME_2 may acquire the identifier of the associated relay UE through the method described in step 4) of FIG. 15.

As described in step 5) of FIG. 11 from the MME, the eNB may perform a procedure for establishing an E-RAB and a procedure for adding an additional DRB according to whether to accept the E-RAB establishment request and whether to add the additional DRB.

Thereafter, the eNB transmits a first RRC message for establishing the data radio bearer (DRB) corresponding to the E-RAB to the relay UE (S16020).

The first RRC message may include the mapping information described in step 4) of FIG. 15 and the allocated local identifier information of the remote UE.

The relay UE receiving the first RRC message from the eNB transmits the PC5 message in order to notify the remote UE that the procedure for establishing the E-RAB and/or the DRB for the remote UE was successfully performed (S16030).

That is, the PC5 message transmitted to the remote UE by the relay UE may be a message indicating that the E-RAB and/or the DRB for the remote UE between the relay UE and the eNB is successfully established and the RRC connection is successfully completed.

In this case, the PC5 message transmitted to the remote UE by the relay UE may include the indicator indicating that the procedure for establishing the E-RAB and/or the DRB for the remote UE is successfully performed.

The remote UE can recognize that the E-RAB and/or the DRB for the remote UE is successfully established by receiving a PC5 message from the relay UE through the PC5 link, and can transmit a response message to the relay UE in response (S16040).

In addition, the remote UE may transition from the EMM-IDLE/RRC-IDLE mode to the EMM-CONNECTED/RRC-CONNECTED mode and perform the operation for the uplink transmission.

The relay UE receiving the response message from the remote UE transmits to the eNB a first RRC response message including a local identifier that the eNB allocates to the remote UE (S16050).

In this case, when the relay UE receives the response message from the remote UE in step S14040, the first RRC response message including the local identifier may be transmitted from the relay UE to the eNB.

The eNB receiving the first RRC response message from the relay UE transmits the S1AP response message to the MME_2 as described in step 7) of FIG. 15 (S16060).

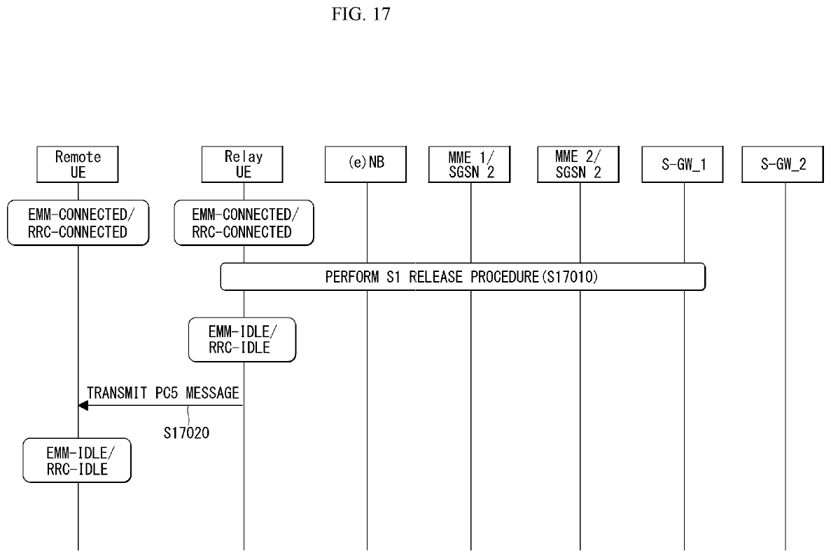

FIG. 17 is a diagram illustrating a method for releasing a radio data bearer according to an embodiment of the present invention.

Referring to FIG. 17, the relay UE may perform an S1 release procedure for the relay UE in order to release the E-RAB for the remote UE established between the relay UE and the eNB in the EMM-CONNECTED/RRC-CONNECTED mode.

Specifically, when the relay UE transitions from the EMM-CONNECTED/RRC-CONNECTED mode to the EMM-IDLE/RRC-IDLE mode and thus the RRC connection is released, the remote UEs linked with the relay UE transition EMM-IDLE/RRC-IDLE mode and thus the RRC connection may be released.

That is, the relay UE and the serving network (for example, eNB, MME_1, S-GW_1, and the like) perform the S1 release procedure described with reference to FIG. 12 (S17010).

While performing the S1 release procedure, the eNB also deletes the related information of the allocated remote UE when configuring the UE context.

In this case, the related information may include at least one of a remote UE ID (for example, local identifier), bearer mapping information, a remote UE bearer context, a remote UE context, or a remote UE S1 UE context.

The relay UE receiving the connection release message for the RRC connection release from the eNB transitions to the EMM-IDLE/RRC-IDLE mode and also deletes the related information of the stored remote UE.

In this case, the related information includes at least one of the remote UE ID (for example, local identifier) or the bearer mapping information.

Thereafter, the relay UE may transmit the PC5 message to the remote UE to notify that the S1 connection and/or the RRC connection is released (S17020).

The PC5 message transmitted by the relay UE to notify the remote UE of the release of the S1 connection and/or the RRC connection may be a DIRECT_COMMUNICATION_RELEASE message, and the release cause included in the release reason IE may be ‘network connection release (for relay UE)’ or ‘S1 connection/RRC connection release (for relay UE)’.

That is, the relay UE may perform step S17020 while performing a direct link release procedure (see 3GPP TS 24.334 v15.1.0) used to release a secure direct link between two ProSe supported UEs.

In this case, the PC5 message transmitted in step S17020 may be a new type of PC5 message.

That is, the PC5 message transmitted in step S17020 may be the PC5 message for notifying ‘network connection release for relay UE’ or ‘s1 connection and/or RRC connection release for relay UE’ or ‘network connection release for relay UE’, or may be the PC5 message including an indicator indicating ‘network connection release for relay UE’ or ‘S1 connection and/or RRC connection release for relay UE’.

In another embodiment of the present invention, when the direct link release procedure is not performed, the PC5 message of step S17020 may be used.

In other words, when the direct link release procedure is performed, the message transmitted in step S17020 may be a DIRECT_COMMUNICATION_RELEASE message, and when the direct link release procedure is not performed, the message transmitted in step S17020 may be a new type of PC5 message.

The remote UE receiving the PC5 message from the relay UE may recognize that the connection between the relay UE and the network (for example, eNB and the like) is released, and notify the upper layer of the included ‘network connection release for relay UE’ or ‘S1 connection and/or RRC connection release for relay UE’.

In this case, when the PC5 message includes an indicator indicating the ‘network connection release for relay UE’ or the ‘S1 connection and/or RRC connection release for relay UE’, the indicator may be delivered to the upper layer.

Thereafter, the NAS layer transitions to the EMM-IDLE/RRC-IDLE state

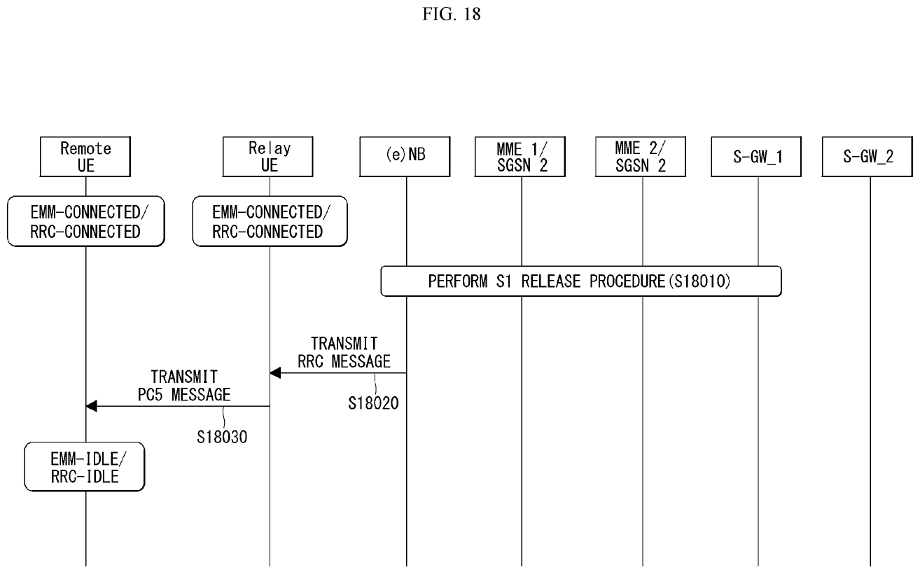

FIG. 18 is a diagram illustrating a method for releasing a radio data bearer according to an embodiment of the present invention.

Referring to FIG. 18, the relay UE may perform the S1 release procedure for the relay UE in order to release the E-RAB for the remote UE established between the relay UE and the eNB while maintaining the EMM-CONNECTED/RRC-CONNECTED mode.

Specifically, the serving network entity (for example, MME_2 and S-GW_2) of the eNB and the remote UE perform the S1 release procedure described with reference to FIG. 12 (S18010).

In this case, in the release procedure performed in step S18010, step 1) and step 5) of FIG. 12 may not be performed.

In this case, if the eNB checks that the remote UE is a remote UE associated with the relay UE, the RRC connection release procedure (see 3GPP TS 23.401 v15.2.0) of a relay UE section is not performed.

The eNB also deletes the related information of the allocated remote UE when configuring the UE context.

In this case, the related information may include at least one of the remote UE ID (for example, local identifier), the bearer mapping information, the remote UE bearer context, the remote UE context, or the remote UE S1 UE context.

Thereafter, the eNB transmits the RRC message notifying that the S1 release procedure of the remote UE is performed to the relay UE (S18020).

The RRC message includes the indicator indicating that the S1 release procedure of the remote UE is performed and the remote UE ID (for example, local identifier).

In this case, the indicator indicating that the S1 release procedure is performed may indicate ‘s1 connection release for remote UE’ or ‘network connection release for remote UE’.

In addition, when the eNB needs to release the DRB of the relay UE supporting the remote UE (for example, when the DRB is a dedicated DRB for supporting the remote UE), the eNB may perform a procedure for releasing the DRB. (See 3GPP TS 36.331 v15.0.1).

In order to perform the procedure for releasing the DRB of the relay UE supporting the remote UE, the eNB transmits to the UE the radioResourceConfigDedicated including the drb-ToReleaseList including the drb-identity indicating the DRB to be released, and the UE performs the procedure for releasing the DRB (see 3GPP TS 36.331 v15.0.1).

In this case, radioResourceConfigDedicated may replace the RRC message of step S18020.

The relay UE receiving the RRC message from the eNB may check the ID of the remote UE included in the RRC message and may transmit the PC5 message to the remote UE to notify that the S1 connection and/or the RRC connection is released (S18030).

In addition, the relay UE also deletes the related information of the stored remote UE.

In this case, the related information includes at least one of the remote UE ID (for example, local identifier) or the bearer mapping information.

The PC5 message transmitted by the Relay UE to notify the remote UE of the release of the S1 connection and/or the RRC connection may be the DIRECT_COMMUNICATION_RELEASE message, and the release cause included in the release reason IE may be the ‘network connection release (for relay UE)’ or the ‘S1 connection/RRC connection release (for relay UE)’.

That is, the relay UE may perform step S18030 while performing a direct link release procedure (see 3GPP TS 24.334 v15.1.0) used to release a secure direct link between two ProSe supported UEs.

In this case, the PC5 message transmitted in step S18020 may be a new type of PC5 message.

That is, the PC5 message transmitted in step S18030 may be the PC5 message for notifying ‘network connection release for relay UE’ or ‘s1 connection and/or RRC connection release for relay UE’ or ‘network connection release for relay UE’, or may be the PC5 message including an indicator indicating ‘network connection release for relay UE’ or ‘S1 connection and/or RRC connection release for relay UE’.

In another embodiment of the present invention, as described with reference to FIG. 17, when the direct link release procedure is performed, the message transmitted in step S18030 may be the DIRECT_COMMUNICATION_RELEASE message, and when the direct link release procedure is not performed, the message transmitted in step S18030 may be a new type of PC5 message.

The remote UE receiving the PC5 message from the relay UE may recognize that the connection between the relay UE and the network (for example, eNB and the like) is released, and notify the upper layer of the included ‘network connection release for relay UE’ or ‘S1 connection and/or RRC connection release for relay UE’.

In this case, when the PC5 message includes an indicator indicating the ‘network connection release for relay UE’ or the ‘S1 connection and/or RRC connection release for relay UE’, the indicator may be delivered to the upper layer.

Thereafter, the NAS layer transitions to the EMM-IDLE/RRC-IDLE state.

Names used in the methods described with reference to FIGS. 1 to 18 may be changed and used as shown in Table 12 below.

TABLE 12

| Existing Name | Changed Name |
|---|---|
| EMM-CONNECTED | CM-CONNECTED |
| (RRC-CONNECTED) mode | (gNB-CONNECTED) mode |
| eNB | gNB |
| MME | AMF (or SMF) |
| MME-EMM (layer) | AMF (5GMM-layer) |
| MME-ESM (layer) | SMF (5GMM-layer) |
| S1AP (interface/message) | N2 (interface/message) |
| NAS (signaling | N1 (connection/interface) |
| connection/interface) | |

The term shown in Table 12 is merely an example, and names for the term may be various.

Overview of Devices to which Present Invention is Applicable

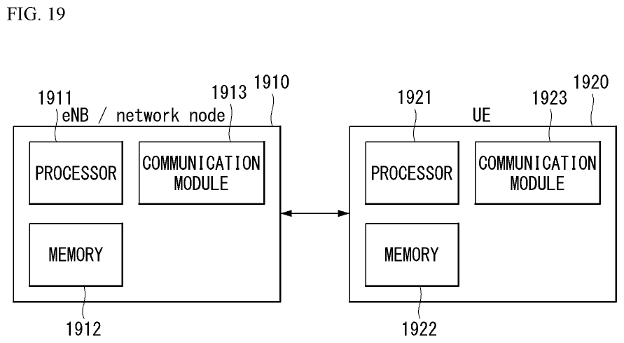

FIG. 19 illustrates a block diagram of a communication apparatus according to an embodiment of the present invention.

Referring to FIG. 19, a wireless communication system includes a network node 1910 and multiple user equipments 1920.

The network node 1910 includes a processor 1911, a memory 1912, and a communication module 1913. The processor 1911 implements a function, a process, and/or a method which are proposed in FIGS. 1 to 23 above. Layers of a wired/wireless interface protocol may be implemented by the processor 1911.

The memory 1912 is connected with the processor 1911 to store various pieces of information for driving the processor 1911. The communication module 1913 is connected with the processor 1911 to transmit and/or receive a radio signal. An example of the network node 1910 may correspond to a base station, MME, HSS, SGW, PGW, SCEF, SCS/AS, etc. In particular when the network node 1910 is the base station, the communication module 1913 may include a radio frequency (RF) unit for transmitting/receiving a radio signal.

The UE 1920 includes a processor 1921, a memory 1922, and a communication module (or RF unit) 1923. The processor 1921 implements a function, a process, and/or a method which are proposed in FIGS. 1 to 23 above. The layers of the wireless interface protocol may be implemented by the processor 1921. In particular, the processor may include an NAS layer and an AS layer. The memory 1922 is connected with the processor 1921 to store various pieces of information for driving the processor 1921. The communication module 1923 is connected with the processor 1921 to transmit and/or receive a radio signal.

The memories 1912 and 1922 may be positioned inside or outside the processors 1911 and 1921 and connected with the processors 1911 and 1921 by various well-known means. Further, the network node 1910 (when the network node 1920 is the base station) and/or the UE 1920 may have a single antenna or multiple antennas.

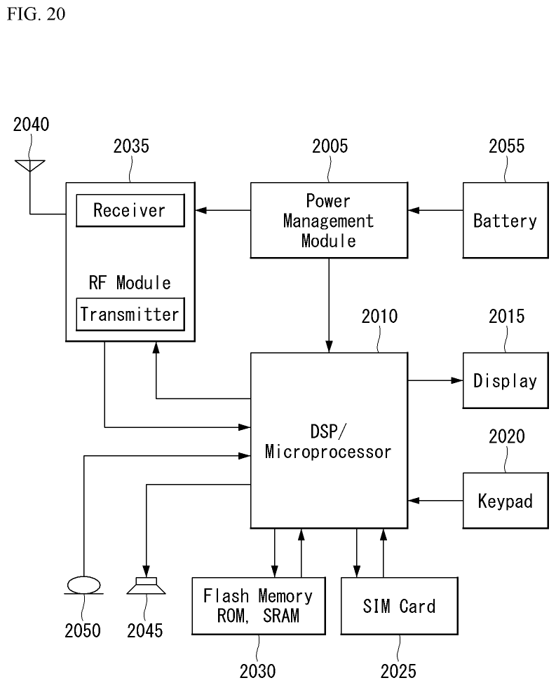

FIG. 20 illustrates a block diagram of a communication apparatus according to an embodiment of the present invention.

In particular, FIG. 20 is a diagram more specifically illustrating the UE of FIG. 23 above.

Referring to FIG. 20, the UE may be configured to include a processor (or a digital signal processor (DSP) 2010, an RF module (or RF unit) 2035, a power management module 2005, an antenna 2040, a battery 2055, a display 2015, a keypad 2020, a memory 2030, a subscriber identification module (SIM) card 2025 (This component is optional), a speaker 2045, and a microphone 2050. The UE may also include a single antenna or multiple antennas.

The processor 2010 implements a function, a process, and/or a method which are proposed in FIGS. 1 to 23 above. Layers of a wireless interface protocol may be implemented by the processor 2010.

The memory 2030 is connected with the processor 2010 to store information related to an operation of the processor 2010. The memory 2030 may be positioned inside or outside the processor 2010 and connected with the processor 2010 by various well-known means.

A user inputs command information such as a telephone number or the like by, for example, pressing (or touching) a button on the keypad 2020 or by voice activation using the microphone 2050. The processor 2010 receives such command information and processes to perform appropriate functions including dialing a telephone number. Operational data may be extracted from the SIM card 2025 or the memory 2030. In addition, the processor 2010 may display command information or drive information on the display 2015 for the user to recognize and for convenience.

The RF module 2035 is connected with the processor 2010 to transmit and/or receive an RF signal. The processor 2010 transfers the command information to the RF module 2035 to initiate communication, for example, to transmit radio signals constituting voice communication data. The RF module 2035 is constituted by a receiver and a transmitter for receiving and transmitting the radio signals. The antenna 2040 functions to transmit and receive the radio signals. Upon receiving the radio signals, the RF module 2035 may transfer the signal for processing by the processor 2010 and convert the signal to a baseband. The processed signal may be converted into to audible or readable information output via the speaker 2045.

In the embodiments described above, the components and the features of the present invention are combined in a predetermined form. Each component or feature should be considered as an option unless otherwise expressly stated. Each component or feature may be implemented not to be associated with other components or features. Further, the embodiment of the present invention may be configured by associating some components and/or features. The order of the operations described in the embodiments of the present invention may be changed. Some components or features of any embodiment may be included in another embodiment or replaced with the component and the feature corresponding to another embodiment. It is apparent that the claims that are not expressly cited in the claims are combined to form an embodiment or be included in a new claim by an amendment after the application.

The embodiments of the present invention may be implemented by hardware, firmware, software, or combinations thereof. In the case of implementation by hardware, according to hardware implementation, the exemplary embodiment described herein may be implemented by using one or more application specific integrated circuits (ASICs), digital signal processors (DSPs), digital signal processing devices (DSPDs), programmable logic devices (PLDs), field programmable gate arrays (FPGAs), processors, controllers, micro-controllers, microprocessors, and the like.

In the case of implementation by firmware or software, the embodiment of the present invention may be implemented in the form of a module, a procedure, a function, and the like to perform the functions or operations described above. A software code may be stored in the memory and executed by the processor. The memory may be positioned inside or outside the processor and may transmit and receive data to/from the processor by already various means.

It is apparent to those skilled in the art that the present invention may be embodied in other specific forms without departing from essential characteristics of the present invention. Accordingly, the aforementioned detailed description should not be construed as restrictive in all terms and should be exemplarily considered. The scope of the present invention should be determined by rational construing of the appended claims and all modifications within an equivalent scope of the present invention are included in the scope of the present invention.

### INDUSTRIAL APPLICABILITY

An example is applied to the 3GPP LTE/LTE-A system is described primarily, but it is possible to apply the RRC connection method to various wireless communication systems, in particular, a 5 generation (G) system in addition to the 3GPP LTE/LTE-A system.

1. A method for transmitting and receiving, by a base station, data of remote user equipment (remote UE) through relay UE in a wireless communication system, comprising:
receiving an S1 application protocol (S1AP) message for establishing an E-UTRAN radio access bearer (E-RAB) of the remote UE from a mobility management entity (MME);
transmitting a first RRC message for establishing a data radio bearer (DRB) corresponding to the E-RAB to the relay UE;
receiving a first RRC response message as a response to the first RRC message from the relay UE; and
transmitting an S1AP response message as a response to an S1AP message to the MME if the first RRC response message includes a local identifier of the remote UE allocated by the base station.

2. The method of claim 1, wherein the local identifier is included in the RRC response message when the relay UE receives a response message from the remote UE, and
the response message is a response message to a message indicating that an RRC connection between the relay UE and the base station is successfully completed.

3. The method of claim 1, further comprising:
receiving a NAS message encapsulated in an RRC message to establish the DRB from the relay UE; and
transmitting the NAS message encapsulated in the S1AP to the MME.

4. The method of claim 3, wherein the NAS message includes an indicator indicating whether the NAS message is relayed through the remote UE and the relay UE.

5. The method of claim 1, wherein the S1AP message includes at least one of UE context information and bearer context information of the relay UE and the remote UE.

6. The method of claim 5, further comprising:
mapping at least one radio data bearer established between the relay UE and the base station to a bearer for the remote UE based on the bearer context information; and
allocating the local identifier for identifying the remote UE.

7. The method of claim 6, wherein the first RRC message includes mapping information associated with the mapping of the at least one radio data bearer and the local identifier.

8. The method of claim 5, further comprising:
establishing an additional DRB for supporting the remote UE when the DRB previously established between the relay UE and the base station is unable to support uplink and downlink transmission of the remote UE.

9. The method of claim 8, wherein it is determined whether the DRB previously established between the relay UE and the base station is unable to support the uplink and downlink transmission of the remote UE based on at least one of authorization of the relay UE or capability of the relay UE.

10. The method of claim 1, wherein the DRB is used for transmitting and receiving a first data of the remote UE or a second data multiplexed with the first data and data of at least one other UE.

11. The method of claim 1, further comprising:
transmitting to the relay UE a second RRC message for releasing only the DRB configured for the remote UE between the base station and the relay UE.

12. The method of claim 1, wherein the S1AP message includes an indicator indicating that the S1AP message is a message for the remote UE.

13. A base station for transmitting and receiving data of remote user equipment (remote UE) through relay UE in a wireless communication system, comprising:
a communication module configured to transmit and receive a wired/wireless signal; and
a processor configured to control the communication module,
wherein the processor receives an S1 application protocol (SLAP) message for requesting a configuration of a UE context of the remote UE (for establishing an E-UTRAN radio access bearer) from a mobility management entity (MME),
transmits a first RRC message for establishing a data radio bearer (DRB) corresponding to the E-RAB to the relay UE,
receives a first RRC response message as a response to the first RRC message from the relay UE, and
transmits an initial context setup response message as a response to an S1AP message to the MME if the first RRC response message includes a local identifier of the remote UE allocated by the base station.
